(19) United States
(12) Patent Application Publication
(10) Pub. No.: US 2026/0171398 A1
(43) Pub. Date: Jun. 18, 2026

(54) Positive Electrode Active Material Layer, Active Material Layer, Positive Electrode, Secondary Battery, and Vehicle

(71) Applicant: Semiconductor Energy Laboratory Co., Ltd., Kanagawa-ken (JP)

(72) Inventors: Shunpei YAMAZAKI, Tokyo (JP); Mayumi MIKAMI, Atsugi (JP); Kazutaka KURIKI, Ebina (JP); Yumiko YONEDA, Isehara (JP); Teruaki OCHIAI, Atsugi (JP); Yuji IWAKI, Isehara (JP)

(73) Assignee: Semiconductor Energy Laboratory Co., Ltd., Kanagawa-ken (JP)

(21) Appl. No.: 19/467,009

(22) Filed: Feb. 2, 2026

Related U.S. Application Data
(63) Continuation of application No. 17/788,483.

(30) Foreign Application Priority Data
Dec. 27, 2019 (JP) 2019-239306
Jan. 23, 2020 (JP) 2020-008976

(51) Int. Cl. H01M 4/36; B60L 50/64; B60L 58/18; C01B 32/198; C01G 53/42; H01M 4/02; H01M 4/131; H01M 4/505; H01M 4/525; H01M 4/62

(52) U.S. Cl. CPC H01M 4/366; B60L 50/64; B60L 58/18; C01B 32/198; C01G 53/42; H01M 4/131; H01M 4/505; H01M 4/525; H01M 4/625; C01P 2002/50; C01P 2002/77; C01P 2004/03; C01P 2004/04; C01P 2004/80; C01P 2006/40; H01M 2004/028; H01M 2220/20

(57) ABSTRACT

A secondary battery with favorable cycle performance is provided. Alternatively, a secondary battery with higher capacity is provided. A positive electrode active material layer including a first graphene layer, a second graphene layer, and a positive electrode active material. The first graphene layer includes a first region covering the positive electrode active material. The second graphene layer includes a second region covering the positive electrode active material and a third region overlapping with the first region. The first region includes a plane positioned between the positive electrode active material and the third region and formed of arranged six-membered carbon rings. The positive electrode active material includes a fourth region with a layered rock-salt structure. A lithium layer with a layered rock-salt structure included in the fourth region is substantially perpendicular to the plane formed of six-membered carbon rings and included in the second region.

This application is a continuation of copending U.S. application Ser. No. 17/788,483, filed on Jun. 23, 2022 which is a 371 of international application PCT/IB2020/061994 filed on Dec. 16, 2020 which are all incorporated herein by reference.

### TECHNICAL FIELD

The present invention relates to an object, a method, or a manufacturing method. Alternatively, the present invention relates to a process, a machine, manufacture, or a composition of matter. In particular, one embodiment of the present invention relates to a semiconductor device, a display device, a light-emitting device, a secondary battery, a power storage device, a storage device, a driving method thereof, or a manufacturing method thereof. In particular, one embodiment of the present invention relates to a secondary battery, a power storage device, and a manufacturing method thereof.

Note that in this specification, a secondary battery or a power storage device refers to every element and device having a function of storing power.

### BACKGROUND ART

In recent years, a variety of power storage devices such as lithium-ion secondary batteries, lithium-ion capacitors, all-solid batteries, and air batteries have been actively developed. In particular, demand for lithium-ion secondary batteries with high output and high energy density has rapidly grown with the development of the semiconductor industry, for portable information terminals such as mobile phones, smartphones, tablets, and laptop personal computers; portable music players; digital cameras; medical equipment; next-generation clean energy vehicles such as hybrid electric vehicles (HVs), electric vehicles (EVs), and plug-in hybrid electric vehicles (PHVs); and the like. The lithium-ion secondary batteries are essential as rechargeable energy supply sources for today's information society.

Lithium-ion batteries using nickel cobalt manganese oxide (NCM) or lithium iron phosphate (LFP) as a positive electrode active material have been commercially available as home-use large secondary batteries or in-vehicle secondary batteries, for example.

In recent years, graphene has been attracting a great deal of attention because of its excellent conductivity and the like, and a large-scale production method and the like have been searched. As described in Non-Patent Document 1, a compound obtained by reduction of graphene oxide (GO) is referred to as reduced GO (RGO) in some cases and the physical property thereof has been attracting attention. For example, there is a study such as Non-Patent Document 2 that characterized the physical property of GO using a scanning electron microscope (SEM), X-ray diffraction (XRD), Raman spectroscopy, and the like. Moreover, as disclosed in Patent Document 1, graphene is used for a secondary battery.

### REFERENCE

### Patent Document

[Patent Document 1] Japanese Published Patent Application No. 2013-030463

### Non-Patent Document

[Non-Patent Document 1]A. Bagri et al., “Structural evolution during the reduction of chemically derived graphene oxide”, NATURE CHEMISTRY, vol. 2, 2010, pp. 581-587.
[Non-Patent Document 2] Burcu Saner et al., “Utilization of multiple graphene nanosheets in fuel cells: 2. The effect of oxidation process on the characteristics of graphene nanosheets”, Fuel, 90, 2011, pp. 2609-2616.

### SUMMARY OF THE INVENTION

### Problems to be Solved by the Invention

Electric vehicles are vehicles in which only an electric motor is used for a driving portion, and there are also hybrid vehicles having both an internal-combustion engine such as an engine and an electric motor. A plurality of secondary batteries used in vehicles are provided as a battery pack, and a plurality of battery packs are provided on the lower portion of a vehicle.

The secondary battery used in an electric vehicle or a hybrid electric vehicle degrades due to the number of charge, the depth of discharge, charging currents, charging environment (temperature change), or the like. The deterioration also depends on the usage of the user; and charging temperatures, frequency of fast charging, charging amount from regenerative braking, charging timing with a regenerative brake, and the like might be related to the deterioration.

The temperature in an electric vehicle depends on the operation state or environment and is easily changed; thus, safety measures for temperature are required. Among components mounted on an electric vehicle, a secondary battery is a power source of the electric vehicle and fulfills the most important function. However, there is a problem in that the temperature range in which a conventional secondary battery can operate normally is narrower than the allowable range of the temperature in which an electric vehicle is used.

The degradation of a secondary battery is likely to proceed by an inner chemical reaction in the state of high ambient temperature, which is a problem. Moreover, there is a problem in that in an extremely cold area where the temperature reaches as low as −50° C., a liquid component in a secondary battery freezes and thus discharge is not caused, losing a function of a secondary battery.

Without limitation to an extremely cold area, the capacity of a lithium-ion secondary battery is reduced when the ambient temperature at which an electric vehicle is used is low, and a lower temperature increases inner resistance and reduces output voltage. Furthermore, when charging is performed at a low temperature, electrodeposition of a lithium metal is caused, leading to sudden degradation.

Thus, an object is to improve a secondary battery to improve its safety.

Moreover, in order to increase the mileage of an electric vehicle, a battery pack with a larger capacity has been needed; however, an increase in the capacity might lengthen charging time.

In order to shorten charging time, fast charging at a high charge rate can be performed; however, a conventional lithium-ion secondary battery has a disadvantage in that degradation of the lithium-ion secondary battery is accelerated by fast charging and timing at which the battery becomes unusable and needs to be replaced comes soon.

In view of the above, an object is to improve a secondary battery to reduce damage to the secondary battery and inhibit degradation, i.e., provide a secondary battery with excellent rate characteristics.

Another object of one embodiment of the present invention is to provide a secondary battery with excellent cycle performance. Another object of one embodiment of the present invention is to provide a higher-capacity secondary battery. Another object of one embodiment of the present invention is to provide a novel power storage device.

Note that the description of these objects does not preclude the existence of other objects. One embodiment of the present invention does not have to achieve all these objects. Other objects can be derived from the description of the specification, the drawings, and the claims.

### Means for Solving the Problems

One embodiment of the present invention is a positive electrode active material layer including a first graphene layer, a second graphene layer, and a positive electrode active material. The first graphene layer includes a first region covering the positive electrode active material. The second graphene layer includes a second region covering the positive electrode active material and a third region overlapping with the first region. The first region includes a plane positioned between the positive electrode active material and the third region and formed of arranged six-membered carbon rings. The positive electrode active material includes a fourth region with a crystal structure of lithium cobalt oxide that is a layered rock-salt structure and represented by a space group R-3m, a crystal structure of lithium nickel-cobalt-manganese oxide, or a crystal structure of a substance represented by LiMO₂ (M is a metal element). A lithium layer with a layered rock-salt structure of the fourth region is substantially perpendicular to the plane formed of six-membered carbon rings of the second region. In the above structure, it is preferable that a third graphene layer be included; the third graphene layer include a plane formed of arranged six-membered carbon rings; the positive electrode active material include a fifth region with a crystal structure of lithium cobalt oxide that is a layered rock-salt structure and represented by a space group R-3m, a crystal structure of lithium nickel-cobalt-manganese oxide, or a crystal structure of a substance represented by LiMO₂ (M is a metal element); and the plane formed of six-membered carbon rings of the third graphene layer and a (104) plane of the layered rock-salt structure of the fifth region include regions substantially parallel to each other.

Another embodiment of the present invention is a positive electrode active material layer including a first graphene layer, a second graphene layer, and a positive electrode active material. The first graphene layer includes a first region covering the positive electrode active material. The second graphene layer includes a second region covering the positive electrode active material and a third region overlapping with the first region. The first region includes a plane positioned between the positive electrode active material and the third region and formed of arranged six-membered carbon rings. The positive electrode active material includes a fourth region with a crystal structure of lithium cobalt oxide that is a layered rock-salt structure and represented by a space group R-3m, a crystal structure of lithium nickel-cobalt-manganese oxide, or a crystal structure of a substance represented by LiMO₂ (M is a metal element). A (104) plane of the crystal structure of the fourth region is substantially parallel to the plane formed of six-membered carbon rings of the second region.

In the above structure, the fourth region is preferably a region including a surface of the positive electrode active material. Alternatively, in the above structure, the fourth region is preferably positioned in a range whose distance from the surface of the positive electrode active material is shorter than 30 nm.

In the above structure, the first graphene layer and the second graphene layer are preferably reduced graphene oxide layers. In the above structure, the positive electrode active material preferably contains lithium, nickel, cobalt, manganese, magnesium, oxygen, and fluorine.

Another embodiment of the present invention is an active material layer including a sheet-like carbon-containing compound and an active material. The carbon-containing compound includes a first region positioned over the active material, a second region positioned over the active material, and a third region positioned over the active material. The second region is thicker than the first region and the third region. A distance between the third region and a surface of the active material is longer than a distance between the second region and the surface of the active material. The active material includes a fourth region with a layered rock-salt structure. A plane formed of a layer of the layered rock-salt structure of the fourth region is substantially perpendicular to a surface of the second region. In the above structure, the distance between the third region and the surface of the active material is preferably longer than a distance between the first region and the surface of the active material.

In the above structure, the fourth region is preferably a region including the surface of the active material. Alternatively, in the above structure, the fourth region is preferably positioned in a range whose distance from the surface of the active material is shorter than 30 nm.

In the above structure, the carbon-containing compound preferably contains graphene.

Another embodiment of the present invention is a positive electrode including the above-described positive electrode active material layer and a current collector. The positive electrode active material layer is provided over the current collector.

Another embodiment of the present invention is a secondary battery including a positive electrode including the above-described positive electrode active material layer, a negative electrode, and an electrolyte.

Another embodiment of the present invention is a vehicle including the above-described secondary battery, an electric motor, and a control device. The control device has a function of supplying power from the secondary battery to the electric motor.

Note that graphene in this specification has a carbon hexagonal lattice structure and includes single-layer graphene or multilayer graphene including two to one hundred layers. Single-layer graphene (one graphene) refers to a one-atom-thick sheet of carbon molecules having sp² bonds. A plurality of graphene refers to multilayer graphene or a plurality of single-layer graphene. Graphene is not limited to being formed of only carbon, may be partly bonded to oxygen, hydrogen, or a functional group, and can also be referred to as a graphene compound. A graphene compound has excellent electrical characteristics of high conductivity and excellent physical properties of high flexibility and high mechanical strength in some cases. A graphene compound has a planar shape. A graphene compound enables low-resistance surface contact. Furthermore, a graphene compound has extremely high conductivity even with a small thickness in some cases and thus allows a conductive path to be formed in an active material layer efficiently even with a small amount. The graphene compound may be formed as a coating film to cover the entire surface of the active material using a spray dry apparatus. Here, it is particularly preferable to use, for example, graphene, multilayer graphene, or RGO as a graphene compound. Note that RGO (reduced graphene oxide) refers to a compound obtained by reducing graphene oxide (GO), for example.

### Effect of the Invention

One embodiment of the present invention can provide a secondary battery with excellent rate characteristics. Another embodiment of the present invention can provide a safer secondary battery. Another embodiment of the present invention can provide a novel power storage device.

### BRIEF DESCRIPTION OF THE DRAWINGS

FIG. 1A is a perspective view illustrating an electrode of one embodiment of the present invention.

FIG. 1B, FIG. 1C, FIG. 1D, and FIG. 1E are cross-sectional views illustrating electrodes of embodiments of the present invention.

FIG. 2A is a cross-sectional view of an electrode, illustrating one embodiment of the present invention. FIG. 2B is a cross-sectional view of an active material layer, illustrating one embodiment of the present invention.

FIG. 3A, FIG. 3B, and FIG. 3C are diagrams each showing an example of graphene.

FIG. 4A, FIG. 4B, FIG. 4C, and FIG. 4D are diagrams related to graphene of one embodiment of the present invention.

FIG. 5A, FIG. 5B, and FIG. 5C are cross-sectional views illustrating an active material layer of one embodiment of the present invention.

FIG. 6A and FIG. 6B are diagrams showing an example of a crystal structure.

FIG. 7 is a cross-sectional view illustrating an active material layer of one embodiment of the present invention.

FIG. 8A and FIG. 8B are cross-sectional views illustrating an active material layer of one embodiment of the present invention.

FIG. 9 is a diagram showing an example of a crystal structure.

FIG. 10 is a diagram showing an example of a crystal structure.

FIG. 11 is a diagram showing an example of a flowchart illustrating one embodiment of the present invention.

FIG. 12 is an example of a process cross-sectional view illustrating one embodiment of the present invention.

FIG. 13 is a STEM image of an active material particle, showing one embodiment of the present invention.

FIG. 14A is a STEM image showing a comparative example, and FIG. 14B is an enlarged image of a part thereof.

FIG. 15A illustrates conditions of this embodiment, and FIG. 15B is a diagram showing a comparative example.

FIG. 16 is a diagram showing cycle performance of secondary batteries.

FIG. 17A is a perspective view of the secondary battery, FIG. 17B is a cross-sectional perspective view of the secondary battery, and FIG. 17C is a schematic cross-sectional view at the time of charge.

FIG. 18A is a perspective view of a secondary battery, FIG. 18B is a cross-sectional perspective view of the secondary battery, FIG. 18C is a perspective view of a battery pack including a plurality of secondary batteries, and FIG. 18D is a top view of the battery pack.

FIG. 19A and FIG. 19B are diagrams showing an example of a secondary battery.

FIG. 20A and FIG. 20B are diagrams showing an example of a secondary battery.

FIG. 21A and FIG. 21B are diagrams showing an example of a secondary battery.

FIG. 22A, FIG. 22B, FIG. 22C, FIG. 22D, and FIG. 22E are perspective views of electronic devices.

FIG. 23A shows charge rate characteristics. FIG. 23B shows discharge rate characteristics.

FIG. 24A and FIG. 24B show cycle characteristics.

FIG. 25A and FIG. 25B show cycle characteristics.

FIG. 26A and FIG. 26B are SEM images.

FIG. 27A and FIG. 27B are SEM images.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

### Embodiment 1

In this embodiment, an electrode for a secondary battery relating to one embodiment of the present invention will be described.

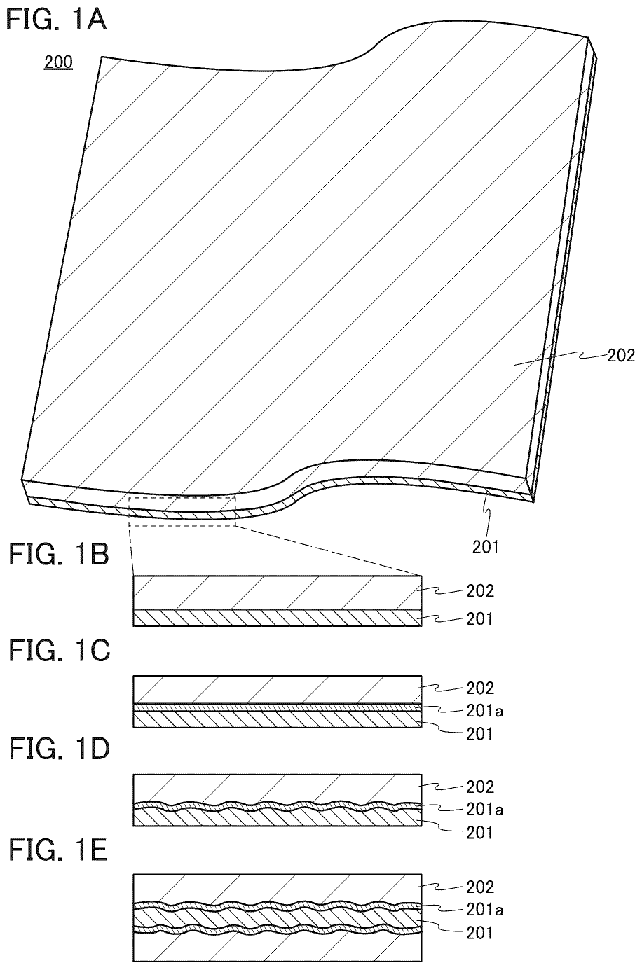

FIG. 1A is a perspective view of an electrode 200. Although the electrode 200 in the shape of a rectangular sheet is illustrated in FIG. 1A, there is no limitation on the shape of the electrode 200 and any shape can be selected as appropriate. The electrode 200 is formed in such a manner that an electrode paste is applied on a current collector 201 and then dried under a reducing atmosphere or reduced pressure to form an active material layer 202. The active material layer 202 is formed on only one surface of the current collector 201 in FIG. 1A but the active material layer 202 may be formed on both surfaces of the current collector 201. The active material layer 202 is not necessarily formed on the entire surface of the current collector 201 and a region that is not coated, such as a region for connection to an electrode tab, can be provided as appropriate.

The current collector 201 can be formed using a highly conductive material which is not alloyed with a carrier ion such as lithium, for example, a metal such as stainless steel, gold, platinum, zinc, iron, copper, aluminum, or titanium, or an alloy thereof. Alternatively, it is possible to use an aluminum alloy to which an element that improves heat resistance, such as silicon, titanium, neodymium, scandium, or molybdenum, is added. Still alternatively, the current collector 201 may be formed using a metal element that forms silicide by reacting with silicon. Examples of the metal element that forms silicide by reacting with silicon include zirconium, titanium, hafnium, vanadium, niobium, tantalum, chromium, molybdenum, tungsten, cobalt, and nickel. The current collector 201 can have a sheet shape, a net shape, a punching-metal shape, an expanded-metal shape, or the like as appropriate. The current collector 201 preferably has a thickness greater than or equal to 10 μm and less than or equal to 30 μm.

As the current collector, a titanium compound may be stacked over the above-described metal element. As a titanium compound, for example, it is possible to use one selected from titanium nitride, titanium oxide, titanium nitride in which oxygen is substituted for part of nitrogen, titanium oxide in which nitrogen is substituted for part of oxygen, and titanium oxynitride (TiOₓN_{y}, where 0<x<2 and 0<y<1), or a mixture or a stack of two or more of them. Titanium nitride is particularly preferable because it has high conductivity and has a high capability of inhibiting oxidation. Provision of a titanium compound over the surface of the current collector inhibits a reaction between a material contained in the active material layer formed over the current collector and the metal element, for example. In the case where the active material layer contains a compound containing oxygen, an oxidation reaction between the metal element and oxygen can be inhibited. In the case where aluminum is used for the current collector and the active material layer is formed using graphene oxide described later, for example, an oxidation reaction between oxygen contained in the graphene oxide and aluminum might occur. In such a case, provision of a titanium compound over aluminum can inhibit an oxidation reaction between the current collector and the graphene oxide.

An example of a method for providing a titanium compound over the current collector will be described. A titanium compound layer may be provided over the current collector using particles of a titanium compound. Alternatively, a titanium compound layer may be provided over the current collector by a thin film method such as an ALD method or a sputtering method. Alternatively, a titanium compound may be provided over the current collector by a sol-gel method.

FIG. 1A is a perspective view showing an example of the electrode 200. The electrode 200 includes the current collector 201 and the active material layer 202 over the current collector 201.

FIG. 1B is an enlarged view of a region surrounded by a dashed-dotted square in FIG. 1A, and is a schematic view illustrating a longitudinal cross-section of the active material layer 202.

FIG. 1C shows an example in which a titanium compound 201a is provided over the surface of the current collector 201 in FIG. 1B.

The surface of the current collector 201 may have unevenness as in an example shown in FIG. 1D and the like. When the surface of the current collector 201 has unevenness, the surface area increases and the contact area between the surface and the active material layer 202 can be increased. An increase in the contact area between the surface and the active material layer 202 can increase the conductivity of the active material layer 202. Furthermore, when the surface of the current collector 201 has unevenness, adhesion between the surface and the active material layer 202 may be improved.

As illustrated in FIG. 1E, the active material layer 202 may be provided over not only one surface but also the other surface of the current collector 201.

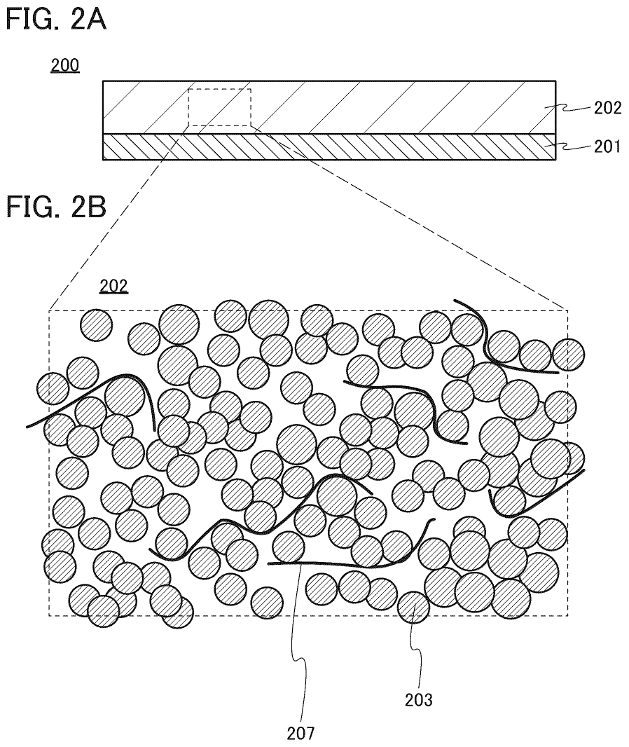

FIG. 2A is an enlarged view of FIG. 1B. FIG. 2B is an enlarged view of a region surrounded by a dashed-dotted square in FIG. 2A.

In an example shown in FIG. 2B, the active material layer 202 includes an active material 203 and a carbon-containing compound 207. The active material layer 202 also includes a binding agent (also referred to as a binder, not illustrated). Note that in the example shown in FIG. 2B, the active material 203 includes particles.

The active material 203 is, for example, a particulate positive electrode active material made of secondary particles having an average particle diameter or particle diameter distribution, which is obtained in such a way that material compounds are mixed at a predetermined ratio and baked and the resulting baked product is crushed, granulated, and classified by an appropriate means. Although the active material 203 is schematically illustrated as spheres in FIG. 2B or the like, the shape of the active material 203 is not limited to this shape.

For the active material 203, a material into and from which lithium ions can be inserted and extracted can be used.

In the case where carrier ions are alkali metal ions other than lithium ions or alkaline-earth metal ions, for the positive electrode active material, an alkali metal (e.g., sodium or potassium), an alkaline-earth metal (e.g., calcium, strontium, barium, beryllium, or magnesium) may be used instead of lithium in the lithium compounds and the lithium-containing composite oxides.

When the active material 203 is a positive electrode active material, examples of the active material 203 include a lithium-containing composite oxide with an olivine crystal structure, a lithium-containing composite oxide with a layered rock-salt crystal structure, and a lithium-containing composite oxide with a spinel crystal structure.

As a positive electrode active material of one embodiment of the present invention, a positive electrode active material with a layered crystal structure is preferably used.

As a layered crystal structure, for example, a layered rock-salt crystal structure is given. As a lithium-containing composite oxide with a layered rock-salt crystal structure, for example, it is possible to use a lithium-containing composite oxide represented by LiMₓO_{y} (x>0 and y>0, specifically y=2 and 0.8<x<1.2, for example). Here, M represents a metal element, preferably one or more selected from cobalt, manganese, nickel, and iron. Alternatively, M represents two or more selected from cobalt, manganese, nickel, iron, aluminum, titanium, zirconium, lanthanum, copper, and zinc, for example.

Examples of the lithium-containing composite oxide represented by LiMₓO_{y} include LiCoO₂, LiNiO₂, and LiMnO₂. In addition, a NiCo-based material represented by LiNiₓCo₁₋ₓO₂ (0<x<1) is given. As the lithium-containing composite oxide represented by LiMₓO_{y}, for example, a NiMn-based material represented by LiNiₓMn₁₋ₓO₂ (0<x<1) is given.

As a lithium-containing composite oxide represented by LiMO₂, for example, a NiCoMn-based material (also referred to as NCM) represented by LiNiₓCo_{y}Mn_{z}O₂ (x>0, y>0, and 0.8<x+y+z<1.2) is given. Specifically, 0.1x<y<8x and 0.1x<z<8x are preferably satisfied, for example. For example, x, y, and z preferably satisfy x:y:z=1:1:1 or the neighborhood thereof. Alternatively, for example, x, y, and z preferably satisfy x:y:z=5:2:3 or the neighborhood thereof. Alternatively, for example, x, y, and z preferably satisfy x:y:z=8:1:1 or the neighborhood thereof. Alternatively, for example, x, y, and z preferably satisfy x:y:z=6:2:2 or the neighborhood thereof. Alternatively, for example, x, y, and z preferably satisfy x:y:z=1:4:1 or the neighborhood thereof.

As a lithium-containing composite oxide with a layered rock-salt crystal structure, Li₂MnO₃ and Li₂MnO₃—LiMeO₂ (Me represents Co, Ni, or Mn) are given, for example.

With use of a positive electrode active material with a layered crystal structure typified by the above-described lithium-containing composite oxide, a secondary battery with a large amount of lithium per volume and high capacity per volume can be provided in some cases. In charging, a large amount of lithium per volume is extracted from such a positive electrode active material; thus, in order to perform stable charging and discharging, the crystal structure needs to be stabilized after the extraction. Moreover, breakage of the crystal structure in charging and discharging may hinder fast charging and fast discharging.

The positive electrode active material of one embodiment of the present invention has a crystal structure that is highly stable in charging and discharging, and thus the positive electrode active material is suitable for also application that requires fast charging and fast discharging.

When the active material 203 is a negative electrode active material, a material with which lithium can be dissolved and precipitated or a material into and from which lithium ions can be inserted and extracted can be used, and, for example, a lithium metal, a carbon-based material, an alloy-based material, or the like can be utilized.

The lithium metal is preferable for its low redox potential (3.045 V lower than that of a standard hydrogen electrode) and high specific capacity per unit weight and per unit volume (3860 mAh/g and 2062 mAh/cm³).

Examples of the carbon-based material include graphite, graphitizing carbon (soft carbon), non-graphitizing carbon (hard carbon), a carbon nanotube, graphene, carbon black, and the like.

Examples of the graphite include artificial graphite such as meso-carbon microbeads (MCMB), coke-based artificial graphite, or pitch-based artificial graphite and natural graphite such as spherical natural graphite.

Graphite has a low potential substantially equal to that of a lithium metal (higher than or equal to 0.05 V and lower than or equal to 0.3 V vs. Li/Li⁺) when lithium ions are intercalated into the graphite (while a lithium-graphite intercalation compound is formed). For this reason, a lithium-ion battery can have a high operating voltage. In addition, graphite is preferred because of its advantages such as relatively high capacity per unit volume, small volume expansion, low cost, and safety greater than that of a lithium metal.

For the negative electrode active materials, an alloy-based material which enables charge-discharge reactions by an alloying reaction and a dealloying reaction with lithium metal can be used. For example, in the case where carrier ions are lithium ions, a material including at least one of Al, Si, Ge, Sn, Pb, Sb, Bi, Ag, Zn, Cd, In, Ga, and the like can be used as the alloy-based material. Such elements have higher capacity than carbon, and in particular, silicon has a significantly high theoretical capacity of 4200 mAh/g. For this reason, silicon is preferably used as the negative electrode active material. Examples of an alloy-based material using such elements include Mg₂Si, Mg₂Ge, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn.

Alternatively, for the negative electrode active material, an oxide such as SiO, SnO, SnO₂, titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

Still alternatively, for the negative electrode active material, Li₃-xMₓN (M=Co, Ni, or Cu) with a Li₃N structure, which is a composite nitride of lithium and a transition metal, can be used. For example, Li_{2.6}Co_{0.4}N₃ is preferable because of high charge and discharge capacity (900 mAh/g).

A composite nitride of lithium and a transition metal is preferably used, in which case the negative electrode active material contains lithium ions and thus can be used in combination with a positive electrode active material that does not contain lithium ions, such as V₂O₅ or Cr₃O₈. Note that in the case of using a material containing lithium ions as a positive electrode active material, the composite nitride of lithium and a transition metal can be used for the negative electrode active material by extracting the lithium ions contained in the positive electrode active material in advance.

Alternatively, a material that causes a conversion reaction can be used for the negative electrode active material. For example, a transition metal oxide that does not cause an alloying reaction with lithium, such as cobalt oxide (CoO), nickel oxide (NiO), and iron oxide (FeO), may be used for the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides can be used as a positive electrode active material because of its high potential.

The active material layer of one embodiment of the present invention preferably includes a carbon-containing compound. The carbon-containing compound preferably functions as a conductive additive of the active material layer.

The carbon-containing compound of one embodiment of the present invention can impart conductivity to the positive electrode active material in the positive electrode active material layer. An insertion reaction and an extraction reaction of lithium in the positive electrode active material are oxidation-reduction reactions during which electrons are transferred, for example, and imparting high conductivity to the positive electrode active material with use of the carbon-containing compound of one embodiment of the present invention facilitates high-speed charging and discharging. Thus, the use of the positive electrode active material layer of one embodiment of the present invention enables high-speed charging and high-speed discharging of a secondary battery.

In the positive electrode active material layer of one embodiment of the present invention, the carbon-containing compound can impart high conductivity to the positive electrode active material and an excellent conductive path can be formed in the active material layer; thus, even when the thickness of the positive electrode active material layer is large, high output characteristics can be obtained. For example, even when the thickness is greater than or equal to 40 □m or greater than or equal to 55 □m, high output characteristics can be obtained. An increase in the thickness of the positive electrode active material layer can increase the capacity per volume of a secondary battery, and when the secondary battery is used for an electric vehicle, the mileage can be increased.

The carbon-containing compound preferably has a sheet-like shape, a plate-like shape, a planar shape, or the like. In the case where the carbon-containing compound has a sheet-like shape or a plate-like shape, the expression “a predetermined surface and the carbon-containing compound are parallel to each other” means, for example, that the thickness direction of the sheet or plate and the normal vector of the predetermined surface are in the same direction. Alternatively, a surface of the sheet or plate is parallel to the predetermined surface. The sheet-like carbon-containing compound can be in surface contact with the active material with low contact resistance. On the surface of the active material, when part of a surface that is substantially perpendicular to the direction in which lithium is inserted and extracted is covered, conductivity is imparted to the active material and diffusion of lithium is promoted in some cases.

In this specification, “parallel” indicates a state where the angle formed between two straight lines is greater than or equal to −10° and less than or equal to 10°. Accordingly, the case where the angle is greater than or equal to −5° and less than or equal to 5° is also included. In addition, the term “approximately parallel” or “substantially parallel” indicates a state where two straight lines are placed at an angle greater than or equal to −30° and less than or equal to 30°. In addition, “perpendicular” indicates a state where the angle formed between two straight lines is greater than or equal to 80° and less than or equal to 100°. Accordingly, the case where the angle is greater than or equal to 850 and less than or equal to 950 is also included. Furthermore, “approximately perpendicular” or “substantially perpendicular” indicates a state where two straight lines are placed at an angle greater than or equal to 60° and less than or equal to 120°.

In the case where the sheet-like carbon-containing compound covers the active material, the entire active material may be covered but it is preferable to cover not the entire active material but part of active material. In the case where the active material is a particle, for example, part of the particle is preferably covered. In the case where the sheet-like carbon-containing compound is bent, it is preferable that at least part of the sheet-like carbon-containing compound do not adhere to the particle and a space where a lithium ion can enter and exit be provided between the carbon-containing compound and the particle. For example, a space that absorbs an electrolyte solution is preferably provided between the carbon-containing compound and the particle.

As the carbon-containing compound, graphene can be used, for example. The graphene has a sheet-like shape, a plate-like shape, a planar shape, or the like. The graphene preferably has a bent shape.

Alternatively, a graphene compound can be used as the carbon-containing compound, for example. A graphene compound is graphene including a functional group, a characteristic group, or the like. Alternatively, the carbon-containing compound may be a graphene mixed sheet that includes graphene, is mixed with another material, and has a sheet-like shape. Alternatively, the carbon-containing compound may be a sheet-like carbon-containing compound formed of a plurality of sheets of graphene.

Graphene or a graphene compound enables low-resistance surface contact. Furthermore, a graphene compound has extremely high conductivity even with a small thickness in some cases and thus allows a conductive path to be formed in an active material layer efficiently even with a small amount. Hence, graphene or a graphene compound is preferably used as the conductive additive, in which case the area where the active material and the conductive additive are in contact with each other can be increased. In addition, a graphene compound is preferable because electrical resistance can be reduced in some cases.

Graphene or a graphene compound has high flexibility and high mechanical strength. Thus, when an electrode including an active material a surface of which is provided with graphene or a graphene compound is used for a battery, the active material can be prevented from being cleaved and cracked due to volume change even when the active material is expanded and contracted, which is caused by charge-discharge of the battery performed repeatedly. Moreover, the pressure applied to the active material can be moderated by mechanical strength of graphene or a graphene compound when the electrode is pressed in a step of manufacturing an electrode. Accordingly, even when stress is applied to the electrode, the active material can be prevented from being cleaved and cracked and the crystal defect of the active material can be prevented from being induced, for example.

Furthermore, at high temperatures, high voltage, or the like, the carbon-containing compound might decompose an electrolyte solution. The decomposition of the electrolyte solution might form a coating film on the surface of the active material and an increase in the resistance of the electrode might occur in charging and discharging. Moreover, the decomposition of the electrolyte solution might generate gas and a region where a contact between the active material and the electrolyte solution is difficult might be generated. Such a decomposition reaction probably occurs between a surface of the carbon-containing compound and the electrolyte solution. Graphene has a small surface area and can form an excellent conductive path with a small amount, so that a surface reaction can be suppressed.

Table 1 shows values, which were measured by a BET method, of specific surface areas of examples of conductive additives: acetylene black (AB), vapor-grown carbon fiber (VGCF) (registered trademark), and graphene oxide (denoted by GO in the table). The graphene oxide was subjected to measurement after an aqueous solution was dried using a spray dryer. It is found that the specific surface area of the acetylene black is significantly large and the specific surface area of the graphene oxide is small.

TABLE 1

| | |
|---|---|
| AB | 63.8 m²/g |
| VGCF | 12.0 m²/g |
| GO | 6.8 m²/g |

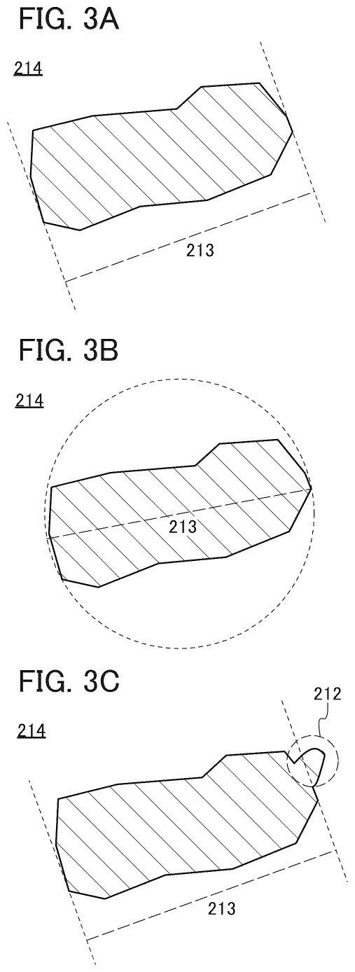

FIG. 3A to FIG. 3C are diagrams showing examples of top views of graphenes or graphene compounds with various shapes.

FIG. 3A is a diagram showing an example of a length 213 of one side of a graphene 214. As illustrated in FIG. 3B, a minimum circle including the graphene 214 is formed in the top view of the graphene 214, and the diameter of the circle may be the length 213 of the one side. It is preferable that a protrusion portion 212 not be included in the length 213 of the one side as illustrated in FIG. 3C. The length 213 of the one side of the graphene 214 is preferably greater than or equal to 50 nm and less than or equal to 100 □m, more preferably greater than or equal to 800 nm and less than or equal to 20 □m.

Graphene may have a sheet-like shape where a plurality of sheets of graphene partly overlap with each other. The sheets of graphene overlapping with each other have a region with a thickness of, for example, greater than or equal to 0.33 nm and less than or equal to 50 □m, preferably greater than 0.34 nm and less than or equal to 10 □m, further preferably greater than 0.34 nm and less than or equal to 50 nm.

As illustrated in FIG. 2B and the like, a plurality of particulate active materials 203 are coated with a plurality of sheet-like or plate-like carbon-containing compounds 207. One sheet of carbon-containing compound 207 may be electrically connected to the plurality of particulate active materials 203. The plurality of particulate active materials 203 form an aggregate in some cases. The carbon-containing compound 207 may be arranged to surround the aggregate. In addition, one sheet of carbon-containing compound 207 may be electrically connected to the plurality of particulate active materials 203 included in the aggregate.

In the case where graphene is used as the carbon-containing compound 207, the graphene does not necessarily overlap with another sheet of graphene only on the surface of the active material layer 202. The graphene is partly provided between a plurality of active material layers 202. The graphene is, for example, an extremely thin film (sheet) made of a single layer of carbon molecules or stacked layers thereof and hence are over and in contact with part of the surfaces of the particulate active materials 203 in such a way as to trace these surfaces. Thus, a portion which is not in contact with the active materials 203 is warped between the plurality of particulate active materials 203 and crimped or stretched.

Here, the plurality of sheets of graphene are bonded to each other, thereby forming net-like graphene (hereinafter referred to as a graphene net). The graphene net covering the active material can function as a binding agent for bonding active materials. The amount of binding agent can thus be reduced, or the binder does not have to be used. This can increase the proportion of the active material in the electrode volume or the electrode weight. That is to say, the capacity of the power storage device can be increased.

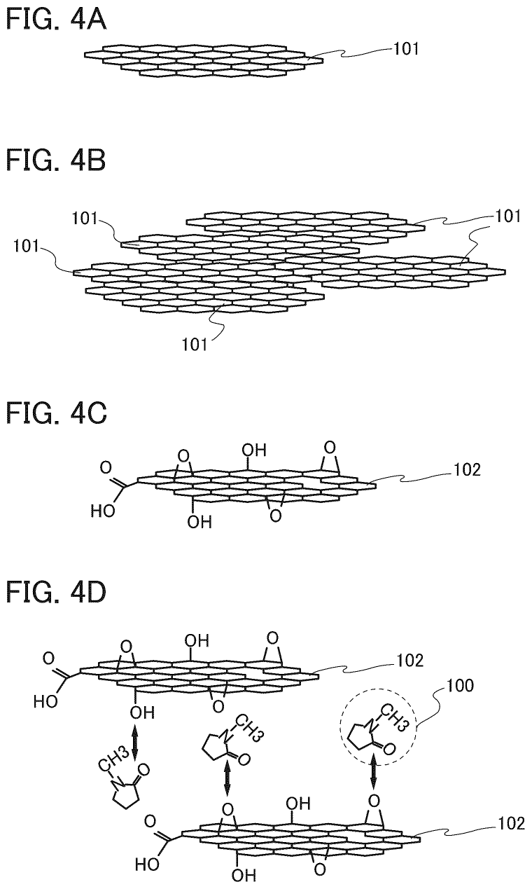

Graphene will be described with reference to FIG. 4. As illustrated in FIG. 4A, in graphene 101, carbon atoms are arranged in a layered manner and six-membered rings composed of carbon are included, for example. As illustrated in FIG. 4, the six-membered rings composed of carbon are arranged to form a plane. The graphene 101 has a π bond between the carbon atoms. The graphene 101 may have a five-membered ring composed of carbon atoms or a poly-membered ring that is a seven or more-membered ring composed of carbon atoms, in addition to a six-membered ring composed of carbon atoms. In the neighborhood of a poly-membered ring other than a six-membered ring, a region through which a lithium ion can pass may be generated.

FIG. 4B illustrates a state where a plurality of sheets of graphene 101 are stacked.

As graphene, graphene including two or more and one hundred or less layers (referred to as multilayer graphene in some cases) can be used.

As graphene, reduced graphene oxide (referred to as RGO in some cases) may be used.

Graphene oxide sometimes includes one or more of a substituent containing oxygen, a functional group containing oxygen, a characteristic group containing oxygen, and oxygen. Examples of a functional group containing oxygen include an epoxy group, a carbonyl group such as a carboxyl group, and a hydroxyl group. FIG. 4C shows an example of graphene oxide.

Graphene oxide includes a functional group, and thus is easily dispersed in a polar solvent. FIG. 4D shows an example of a state where graphene oxide is dispersed in NMP (N-methyl-2-pyrrolidone). NMP is a compound having a five-membered ring structure and is one of polar solvents. In the NMP, oxygen is electrically negatively (−)biased and carbon forming a double bond with the oxygen is electrically positively (+)biased. Graphene oxide is added to a diluent solvent having such a polarity. Oxygen in the functional group in the graphene oxide is negatively charged; hence, in a polar solvent, different graphene oxides hardly aggregate but strongly interact with the NMP which is a polar solvent. Thus, the functional group such as an epoxy group included in the graphene oxide interacts with the polar solvent, which inhibits aggregation of graphene oxides; consequently, the graphene oxide is uniformly dispersed in a dispersion medium.

In reduced graphene oxide, in some cases, part of oxygen or a substituent, functional group, or characteristic group containing oxygen remains in some cases. In some cases, reduced graphene oxide includes a functional group, e.g., an epoxy group, a carbonyl group such as a carboxyl group, or a hydroxyl group.

The length of one side (also referred to as a flake size) of the graphene oxide is greater than or equal to 50 nm and less than or equal to 100 μm, preferably greater than or equal to 800 nm and less than or equal to 20 μm. Particularly in the case where the flake size is smaller than the average particle diameter of the particulate active materials 203, surface contact with the plurality of active materials 203 and connection among the sheets of graphene become difficult, resulting in difficulty in improving the electron conductivity of the active material layer 202.

Graphene oxide includes a functional group, and thus has extremely high dispersibility in a polar solvent. Thus, in a manufacturing process of the active material layer, when graphene oxide and the active material are mixed, they are well dispersed. After the mixing, the graphene oxide is reduced, whereby reduced graphene is obtained. When graphene oxide is used for the formation of the active material layer, graphene can be substantially uniformly dispersed in the active material layer 202. The solvent is removed by volatilization from a dispersion medium containing the uniformly dispersed graphene oxide to reduce the graphene oxide and obtain graphene; hence, sheets of graphene remaining in the active material layer 202 partly overlap with each other and are dispersed such that surface contact is made, thereby forming a three-dimensional conduction path. Note that graphene oxide can be reduced by heat treatment or with the use of a reducing agent, for example.

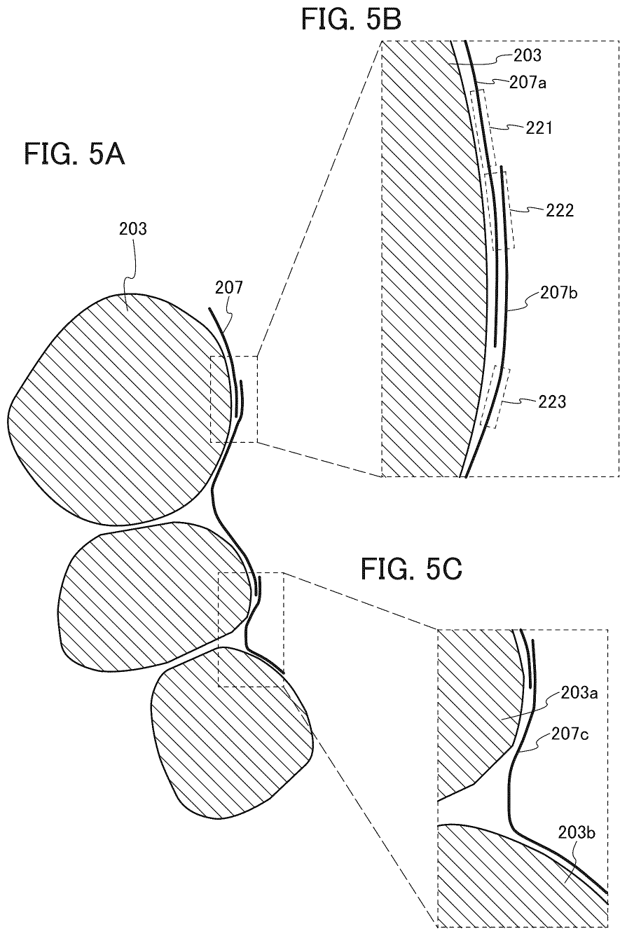

FIG. 5A shows an example of the active material 203 and the carbon-containing compound 207 in a cross section of the active material layer 202. FIG. 5B and FIG. 5C show enlarged views of regions indicated by dashed-dotted squares in FIG. 5A.

The case is considered where the carbon-containing compound 207 is graphene in FIG. 5B. In FIG. 5B, a surface of the active material 203 is covered with a carbon-containing compound 207a, which is first graphene, and a carbon-containing compound 207b, which is second graphene. The carbon-containing compound 207a includes a region that overlaps with the carbon-containing compound 207b and is interposed between the active material 203 and the carbon-containing compound 207b.

Here, in FIG. 5B, the carbon-containing compound 207a and the carbon-containing compound 207b are regarded as one continuous carbon-containing compound in some cases. In such one continuous carbon-containing compound in FIG. 5B, for example, a region 221 is a region, which does not overlap with the carbon-containing compound 207b, of the carbon-containing compound 207a; a region 222 is a region where the carbon-containing compound 207a and the carbon-containing compound 207b overlap with each other; and a region 223 is a region, which does not overlap with the carbon-containing compound 207a, of the carbon-containing compound 207b. In FIG. 5B, the thickness of the region 222 is greater than those of the region 221 and the region 223. In FIG. 5B, the distance between the region 223 and the surface of the active material 203 is longer than the distance between the region 222 and the active material 203. The distance between the region 223 and the surface of the active material 203 is longer than the distance between the region 221 and the active material 203. The distance between the region 223 and the surface of the active material 203 may be the distance between a surface, which is close to the active material 203, of the region 223 and the active material 203, for example. The distance between the region 222 and the surface of the active material 203 may be the distance between a surface, which is close to the active material 203, of the region 222 and the active material 203, for example. The distance between the region 221 and the surface of the active material 203 may be the distance between a surface, which is close to the active material 203, of the region 221 and the active material 203, for example.

In the case where metal elements serving as carrier ions, such as lithium, are arranged in a layered manner in a layered crystal structure, the metal elements are likely to be diffused along the layer in some cases.

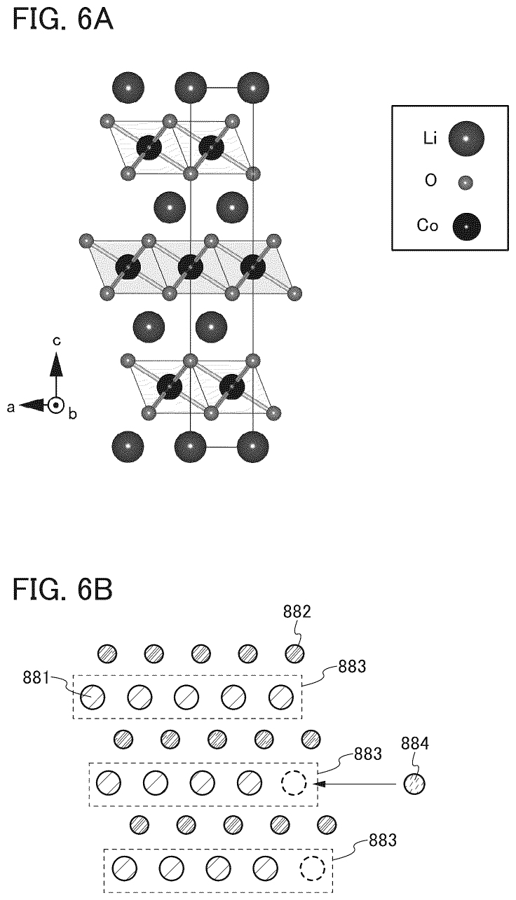

FIG. 6A illustrates a crystal structure of LiCoO₂, which is a layered rock-salt structure. In FIG. 6A, lithium atoms are arranged as a layer perpendicular to the c-axis (hereinafter, referred to as a lithium layer), and the layer and a CoO₂ layer containing cobalt and oxygen are alternately stacked. The lithium atoms are likely to be diffused along the lithium layer. Thus, when a cross section of the lithium layer is exposed on the surface of the active material 203, insertion of a lithium atom into the lithium layer and extraction of a lithium atom from the lithium layer easily occur. For example, in the case where the active material 203 has a layered rock-salt structure, the cross section of the lithium layer is preferably exposed on the surface of the active material 203.

For example, in an active material that is represented by LiMO₂ (M represents a metal element) and has a space group R-3m, a plane including the c-axis is preferably exposed. Alternatively, for example, a plane substantially perpendicular to an ab plane is preferably exposed, and for example, a plane that forms an angle of greater than or equal to 70° and less than or equal to 110° with respect to the ab plane is preferably exposed. Here, the ab plane is a plane including the a-axis direction and the b-axis direction in the plane. In addition, the surface energy of a (104) plane is stable in an active material that is represented by LiMO₂ (M represents a metal element) and has a space group R-3m. Therefore, for example, the (104) plane is preferably exposed on the surface of the positive electrode active material.

Alternatively, the cross section of the lithium layer is not necessarily exposed on the outermost surface of the active material 203. For example, a coating film may be provided on the cross section of the lithium layer and the carbon-containing compound 207 may be provided on and in contact with the coating film. Alternatively, a region with low crystallinity may be provided on the cross section of the lithium layer and the carbon-containing compound 207 may be provided on and in contact with the region.

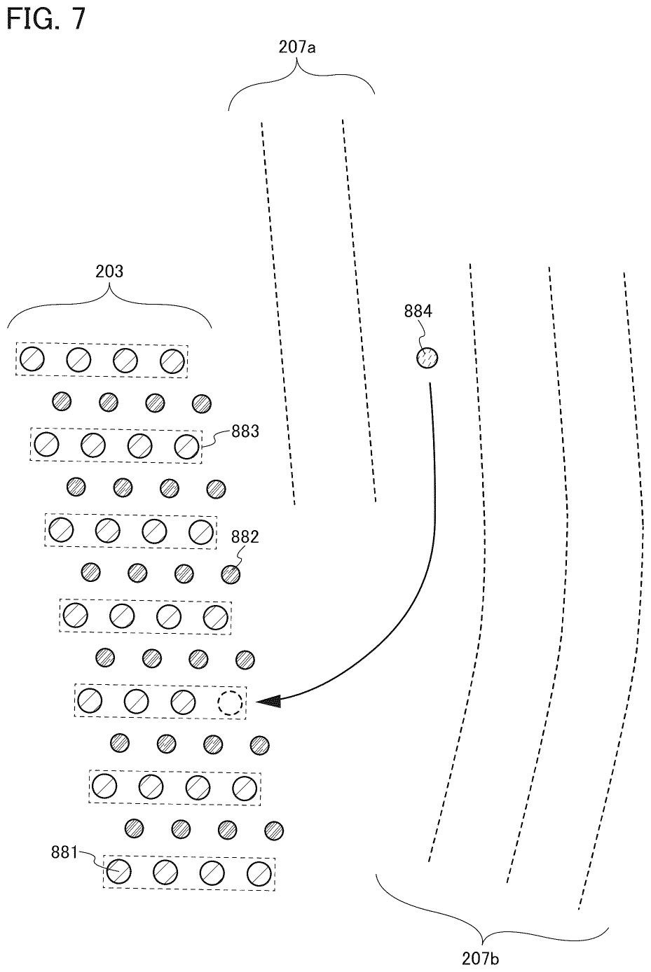

FIG. 6B is a diagram of the crystal structure of LiCoO₂ that is simplified for explanation. A lithium ion 884 that exists in an electrolyte receives an electron and enters a crystal from a lithium layer 883. A lithium atom 881 that has entered the crystal is diffused along the lithium layer 883. For simplicity, FIG. 6B and FIG. 7 and the like described later illustrate only a cobalt atom 882 in a CoO₂ layer.

FIG. 7 shows an enlarged schematic view of part of FIG. 5B. Note that an atom such as a carbon atom is not illustrated in the carbon-containing compound in FIG. 7.

In FIG. 7, the carbon-containing compound 207a covers part of a region where the cross section of the lithium layer is exposed in the active material 203. The carbon-containing compound 207a and the carbon-containing compound 207b overlap substantially in parallel with the surface of the active material 203. The carbon-containing compound 207a and the carbon-containing compound 207b preferably have a sheet-like shape, and when sheet-like carbon-containing compounds are stacked, a path through which lithium passes can be formed. In the case where lithium exists in an electrolyte solution as a lithium ion, it is considered that solvation of at least part of lithium ions occurs with a solvent. In the case where a lithium ion passes between the carbon-containing compound 207a and the carbon-containing compound 207b, desolvation of the lithium ion may occur. The lithium ion 884 passes between the carbon-containing compound 207a and the carbon-containing compound 207b overlapping with each other and is transferred to the vicinity of the region where the cross-section of the lithium layer is exposed on the surface of the active material 203. The lithium ion 884 reaches the region where the cross-section of the lithium layer is exposed on the surface of the active material 203, the lithium ion 884 receives an electron, and lithium enters the active material 203.

The active material 203 includes a region covered with the carbon-containing compound 207a in the surface or in the vicinity of the surface (hereinafter, a first region). The first region of the active material 203 has a layered crystal structure. The carbon-containing compound 207a includes a portion overlapping with the first region of the active material 203 (hereinafter, a first portion). Note that the carbon-containing compound 207a is preferably in contact with the first region of the active material 203. Alternatively, the distance between the carbon-containing compound 207a and the first region of the active material 203 is preferably shorter than 30 nm, shorter than 15 nm, or shorter than 5 nm, for example. The first portion of the carbon-containing compound 207a overlaps with the carbon-containing compound 207b.

The first portion of the carbon-containing compound 207a is preferably parallel or substantially parallel to a plane including the c-axis direction of the crystal structure included in the first region of the active material 203.

Alternatively, the first portion of the carbon-containing compound 207a is preferably parallel or substantially parallel to the (104) plane of the crystal structure included in the first region of the active material 203.

Alternatively, the first portion of the carbon-containing compound 207a preferably forms an angle of greater than or equal to 70° and less than or equal to 110° with respect to the ab plane of the crystal structure included in the first region of the active material 203.

The vicinity of the surface of the active material 203 means, for example, a region apart from the surface by a distance shorter than 30 nm, shorter than 15 nm, or shorter than 5 nm.

A portion of graphene which is not in contact with the active materials 203 may be warped between the plurality of particulate active materials 203 and crimped or stretched. In FIG. 5C, a surface of the active material 203a, which is a first active material, and a surface of the active material 203b, which is a second active material, are covered with the carbon-containing compound 207c, which is third graphene. The carbon-containing compound 207c is bent between the active material 203a and the active material 203b.

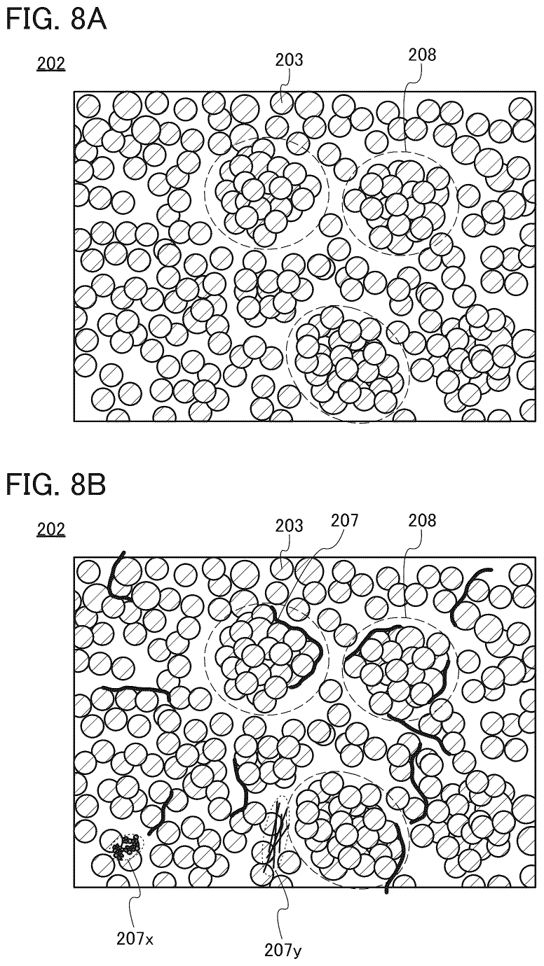

FIG. 8A shows an enlarged view of a cross section of the active material layer 202 as an example of the active material layer 202. As illustrated in FIG. 8A, a plurality of active materials 203 may form a secondary particle 208 in the active material layer 202. Formation of the secondary particle 208 by the plurality of active materials 203 may increase the strength of the active material layer 202. The strength of the active material layer 202 indicates, for example, the resistance to the peeling test, the inhibition of collapse of the active material from the active material layer 202 after charging/discharging, or the like. Alternatively, in the case where the secondary particle 208 is formed with the plurality of active materials 203, for example, the density of the active material layer 202 can be likely to be increased in some cases. An increase in the density of the active material layer 202 enables the energy density of the secondary battery to be increased. The secondary particle corresponds to, for example, an aggregated portion formed by a plurality of active materials.

As illustrated in FIG. 8B, the carbon-containing compound 207 preferably covers at least part of the secondary particle 208.

In the case where the active material 203 is particulate, the average particle diameter of primary particles is greater than or equal to 10 nm and less than or equal to 100 μm. In the case where the average particle diameter of primary particles is less than 5 □m, less than 3 □m, less than or equal to 1.5 □m, less than or equal to 900 nm, or less than or equal to 300 nm, for example, the active materials 203 preferably form a secondary particle in the active material layer.

The average particle diameter of the secondary particle is preferably greater than or equal to 1 μm and less than or equal to 100 μm, further preferably greater than or equal to 3 μm and less than or equal to 30 μm.

In the case where the first active materials and the second active materials that have different average particle diameters are mixed in the active material layer, active materials with a smaller average particle diameter preferably form a larger number of secondary particles.

In the case where the first active material and the second active material are different materials, they are sometimes different from each other in a discharge curve, specifically, discharge voltage, the gradient of a discharge curve, or the like. In such a case, when the first active material and the second active material are mixed, an inflection point appears in the discharge curve of a secondary battery and capacity may be easily detected. Furthermore, when the first active material and the second active material are mixed, degradation of a secondary battery is suppressed in some cases.

The positive electrode active material layer of one embodiment of the present invention preferably includes, for example, lithium cobalt oxide in which the average particle diameter of primary particles is greater than or equal to 5 μm and less than or equal to 100 μm and lithium nickel-cobalt-manganese oxide in which the average particle diameter of primary particles is greater than or equal to 10 nm and less than 5 μm; the lithium nickel-cobalt-manganese oxide forms a secondary particle; and the average particle diameter of the secondary particles is preferably greater than or equal to 5 μm and less than or equal to 100 μm.

The active material layer 202 may include, in addition to the sheet-like carbon-containing compound 207, a particulate carbon-containing compound 207x (see FIG. 8B).

The active material layer 202 may include, in addition to the sheet-like carbon-containing compound 207, a fibrous carbon-containing compound 207y (see FIG. 8B).

As a particulate carbon-containing compound, a carbon material such as carbon black (AB or the like) or a graphite particle can be used, for example.

As a fibrous carbon-containing compound, VGCF (registered trademark) can be used, for example. Alternatively, fibrous graphene or a compound that is curled up graphene like a carbon nanofiber can be used. Alternatively, a conductive polymer can be used. Alternatively, the carbon-containing compound may be a thread-like material. Fibrous or thread-like carbon-containing compounds are preferably in contact with each other to form a conductive path. Alternatively, a fibrous or thread-like carbon-containing compound and a sheet-like carbon-containing compound are preferably in contact with each other to form a conductive path. It is preferable that the conductive path formed with carbon-containing compounds be electrically connected to the active material 203.

A particulate carbon-containing compound and a fibrous carbon-containing compound easily enter a microscopic space. When a carbon-containing compound that easily enters a microscopic space and a sheet-like carbon-containing compound that can impart conductivity to a plurality of particles are used in combination, an excellent conductive path can be formed.

The surface resistivity of the graphene of one embodiment of the present invention is preferably lower than or equal to 1×10⁴ Ω/square, further preferably lower than or equal to 50 Ω/square.

In the case where graphene includes two or more layers, the interlayer distance between adjacent graphene layers is preferably longer than or equal to 0.33 nm and shorter than or equal to 0.5 nm, more preferably longer than 0.34 nm and shorter than or equal to 0.5 nm. The interlayer distance of graphene can be measured by observing a cross section with a transmission electron microscope (TEM). The interlayer distance can be calculated (as interplanar spacing) by X-ray diffraction (XRD).

The oxygen concentration of the graphene of one embodiment of the present invention measured by XPS (X-ray photoelectron spectroscopy measurement) is, for example, lower than or equal to 20 atomic %, preferably higher than or equal to 2 atomic % and lower than or equal to 20 atomic %, further preferably higher than or equal to 2 atomic % and lower than or equal to 11 atomic %, or still further preferably higher than or equal to 3 atomic % and lower than or equal to 10 atomic %.

In the case where graphene is analyzed by XPS and the spectrum of binding energy of carbon corresponding to C1s is subjected to waveform separation, the proportion of peaks indicating sp² with respect to the whole spectrum of C1s can be estimated as an area ratio. The proportion of sp² in the graphene of one embodiment of the present invention is preferably higher than or equal to 50% and lower than or equal to 90% of the whole spectrum of C1s. Increasing the proportion of sp² can heighten the conductivity of the graphene, for example.

Note that physical values such as the interplanar spacing, the oxygen concentration, and the electrical conductivity given above are only examples, and those of the graphene compound of one embodiment of the present invention are not limited thereto.

The graphene oxide of one embodiment of the present invention may have a lower electrical conductivity than graphene. For example, when the surface resistivity of the graphene oxide is measured, a value greater than or equal to 1×10⁵ Ω/square is obtained in some cases.

The oxygen concentration, which is measured by XPS (X-ray photoelectron spectroscopy measurement), of the graphene oxide of one embodiment of the present invention may exceed 30 atomic□ of the whole graphene oxide, for example. Reduction of graphene oxide can increase conductivity. Reduction of the graphene oxide of one embodiment of the present invention can make oxygen concentration lower than or equal to 20 atomic□ in some cases.

Note that the above descriptions are only examples, and those of the graphene of one embodiment of the present invention are not limited thereto.

As the binding agent included in the active material layer 202, besides polyvinylidene fluoride (PVDF) as atypical one, polyimide, polytetrafluoroethylene, polyvinyl chloride, ethylene-propylene-diene polymer, styrene-butadiene rubber, acrylonitrile-butadiene rubber, fluorine rubber, polyvinyl acetate, polymethyl methacrylate, polyethylene, nitrocellulose or the like can be used.

The content of reduced graphene oxide contained in the positive electrode active material layer is greater than or equal to 0.5 wt % and less than or equal to 10 wt %, preferably greater than 1 wt % and less than or equal to 5 wt % with respect to the total amount of active material, conductive additive, and binding agent. The binding agent may be contained at greater than or equal to 1 wt % and less than or equal to 10 wt %.

The density of the active material layer accounts for, for example, higher than or equal to 30%, further preferably higher than or equal to 50%, still further preferably higher than or equal to 70% of the density of materials used for the active material. In the case where LiFePO₄ is used for the active material in the active material layer of one embodiment of the present invention, the density of the active material layer is preferably 1.1 g/cm³, further preferably higher than or equal to 1.8 g/cm³, still further preferably higher than or equal to 2.6 g/cm³.

Graphene is formed in such a manner that, for example, a reduction treatment is performed on a graphene oxide whose atomic ratio of oxygen to carbon is greater than or equal to 0.405.

The graphene oxide whose atomic ratio of oxygen to carbon is greater than or equal to 0.405 can be formed by an oxidation method called a Hummers method.

In the Hummers method, a sulfuric acid solution of potassium permanganate, a hydrogen peroxide solution, or the like is mixed into graphite powder to cause an oxidation reaction; thus, a dispersion liquid containing graphite oxide is formed. Through the oxidation of carbon in graphite, functional groups such as an epoxy group, a carbonyl group, a carboxyl group, or a hydroxyl group are bonded in the graphite oxide. Accordingly, the interlayer distance between a plurality of sheets of graphene in the graphite oxide is longer than that in the graphite, so that the graphite oxide can be easily separated into thin pieces by interlayer separation. Then, ultrasonic vibration is applied to the dispersion liquid containing the graphite oxide, so that the graphite oxide whose interlayer distance is long can be cleaved to separate into graphene oxides and to form a dispersion liquid containing graphene oxides. The solvent is removed from the dispersion liquid containing the graphene oxides, so that powdery graphene oxide can be obtained.

Here, the amount of an oxidizer such as potassium permanganate is adjusted as appropriate so that the graphene oxide whose atomic ratio of oxygen to carbon is greater than or equal to 0.405 can be formed. That is, the amount of the oxidizer with respect to the graphite powder is increased, and accordingly the degree of oxidation of the graphene oxide (the atomic ratio of oxygen to carbon) can be increased. The amount of the oxidizer with respect to the graphite powder which is a raw material can be determined depending on the amount of graphene oxide to be formed.

Note that the method for forming graphene oxide is not limited to the Hummers method using a sulfuric acid solution of potassium permanganate; for example, the Hummers method using nitric acid, potassium chlorate, sodium nitrate, or the like or a method for forming graphene oxide other than the Hummers method may be employed as appropriate.

Graphite oxide may be separated into thin pieces by application of ultrasonic vibration, by irradiation with microwaves, radio waves, or thermal plasma, or by application of physical stress.

This embodiment can be implemented in appropriate combination with the other embodiments.

### Embodiment 2

In this embodiment, graphene in the electrode of the secondary battery of one embodiment of the present invention will be described.

Graphene is a carbon material having a crystal structure in which hexagonal skeletons of carbon are spread in a planar form. Graphene is one atomic plane extracted from graphite crystals. Due to its electrical, mechanical, or chemical characteristics which are surprisingly excellent, graphene has been expected to be applied to a variety of fields of, for example, field-effect transistors with high mobility, highly sensitive sensors, highly-efficient solar cells, and next-generation transparent conductive films and has attracted a great deal of attention.

In this specification, a graphene includes single-layer graphene or multilayer graphene including two to hundred layers in its category. Single-layer graphene refers to a one-atomic-layer thick sheet of carbon molecules having π bonds. Graphene oxide refers to a compound formed by oxidation of such graphene. When graphene oxide is reduced to form graphene, oxygen contained in the graphene oxide is not entirely released and part of the oxygen remains in the graphene. When the graphene contains oxygen, the ratio of the oxygen to the entire graphene measured by XPS is higher than or equal to 2 atomic % and lower than or equal to 20 atomic %, preferably higher than or equal to 3 atomic % and lower than or equal to 15 atomic %.

In the case where the graphene is multilayer graphene including graphene obtained by reducing graphene oxide, the interlayer distance of the graphene is greater than or equal to 0.34 nm and less than or equal to 0.5 nm, preferably greater than or equal to 0.38 nm and less than or equal to 0.42 nm, further preferably greater than or equal to 0.39 nm and less than or equal to 0.41 nm. In general graphite, the interlayer distance of single-layer graphene is 0.34 nm. Since the interlayer distance in the graphene used for the secondary battery of one embodiment of the present invention is longer than that in the general graphite, carrier ions can easily transfer between layers of the graphene in the multilayer graphene.

In the electrode for a secondary battery of one embodiment of the present invention, graphene is dispersed so as to overlap with each other in an active material layer and be in contact with a plurality of active material particles. In other words, an electron conductive network is formed by the graphene in an active material layer. This maintains bonds between the plurality of active material particles, which enables an active material layer with high electron conductivity to be formed.

An active material layer to which a graphene is added as a conductive additive can be formed by the following method. First, after the graphene is dispersed into a dispersion medium (also referred to as a solvent), an active material is added thereto and a mixture is obtained by mixing. A binding agent is added to this mixture and mixing is performed, so that an electrode paste is formed. Lastly, after the electrode paste is applied to a current collector, the dispersion medium is volatilized. Thus, the active material layer including graphene as a conductive additive is formed.

A graphene oxide is a polar substance having a functional group such as an epoxy group, a carbonyl group, a carboxyl group, or a hydroxyl group. The functional group such as an epoxy group included in the graphene oxide interacts with a polar solvent, which inhibits aggregation of graphene oxides; consequently, the graphene oxide is considered to be uniformly dispersed in a dispersion medium.

In view of the foregoing, in order that a network with high electron conductivity be formed in an active material layer by using the graphene as a conductive additive, use of the graphene oxide with high dispersibility in a dispersion medium in manufacture of an electrode paste is very effective. The dispersion property of graphene oxide in a dispersion medium probably depends on the quantity of functional groups having oxygen such as an epoxy group (in other words, the degree of oxidation of graphene oxide).

Therefore, one embodiment of the present invention is a graphene oxide used as a raw material of a conductive additive used in an electrode for secondary battery, and is a graphene oxide in which the atomic ratio of oxygen to carbon is greater than or equal to 0.405.

Here, the atomic ratio of oxygen to carbon is an indicator of the degree of oxidation and represents the weight of oxygen which is a constituent element of the graphene oxide as a proportion with respect to the weight of carbon which is a constituent element of the graphene oxide. Note that the weights of elements included in graphene oxide can be measured by X-ray photoelectron spectroscopy (XPS), for example.

The atomic ratio of oxygen to carbon in the graphene oxide which is greater than or equal to 0.405 means that the graphene oxide is a polar substance in which functional groups such as an epoxy group, a carbonyl group, a carboxyl group, or a hydroxyl group are sufficiently bonded to the graphene oxide for the high dispersibility of the graphene oxide in a polar solvent.

The graphene oxide in which the atomic ratio of oxygen to carbon is greater than or equal to 0.405 is dispersed into a dispersion medium together with an active material and a binder, mixed, and applied on a current collector, and heating is performed. Thus, an electrode for a secondary battery which includes graphene with a high dispersion property and an electron conductive network can be formed.

The length of one side of the graphene oxide is preferably greater than or equal to 50 nm and less than or equal to 100 μm, further preferably greater than or equal to 800 nm and less than or equal to 20 μm.

Another embodiment of the present invention is an electrode for a secondary battery which includes an active material layer including a plurality of particulate active materials, a conductive additive including a plurality of sheets of graphene, and a binding agent over a current collector. The graphene in each sheet is larger than an average particle diameter of each of the particulate active materials. The graphene is dispersed in the active material layer such that the graphene make surface contact with one or more adjacent sheets of graphene. The graphene make surface contact in such a way as to wrap part of a surface of the particulate active material.

Another embodiment of the present invention is an electrode for a secondary battery which includes an active material layer including a plurality of particulate active materials, a conductive additive including a plurality of sheets of graphene, and a binding agent over a current collector. As bonding states of carbon included in the active material layer, the proportion of a C═C bond is greater than or equal to 35% and the proportion of a C—O bond is greater than or equal to 5% and less than or equal to 20%.

Another embodiment of the present invention is a method for manufacturing an electrode for a secondary battery, in which a graphene oxide in which the atomic ratio of oxygen to carbon is greater than or equal to 0.405 is dispersed into a dispersion medium; an active material is added to the dispersion medium into which the graphene oxide is dispersed and mixing is performed to form a mixture; a binding agent is added to the mixture and mixing is performed to form an electrode paste; the electrode paste is applied on a current collector; and the graphene oxide is reduced after or at the same time when the dispersion medium included in the applied positive electrode paste is volatilized, whereby an active material layer including the graphene is formed over the current collector.

When the graphene contains oxygen, the ratio of the oxygen to the entire graphene measured by XPS is higher than or equal to 2 atomic % and lower than or equal to 20 atomic %, preferably higher than or equal to 3 atomic % and lower than or equal to 15 atomic %. As the ratio of oxygen is lower, the conductivity of the graphene can be higher, so that a network with high electron conductivity can be formed. As the ratio of oxygen becomes higher, more gaps serving as paths of ions can be formed in the graphene.

The content of reduced graphene oxide contained in the positive electrode active material layer is greater than or equal to 0.5 wt % and less than or equal to 10 wt %, preferably greater than 1 wt % and less than or equal to 5 wt %.

This embodiment can be implemented in appropriate combination with the other embodiments.

### Embodiment 3

In this embodiment, an example of a structure of a positive electrode active material manufactured by a manufacturing method of one embodiment of the present invention is described.

A positive electrode active material of one embodiment of the present invention includes fluorine. Fluorine can improve the wettability of a surface of the positive electrode active material, so that the surface can be homogenized. The crystal structure of the positive electrode active material obtained in this manner is less likely to be broken with repeated high-voltage charge and discharge, and a secondary battery including the positive electrode active material having such a feature has greatly improved cycle characteristics.

When the unevenness of the surface of an active material particle of the positive electrode active material of one embodiment of the present invention falls within a certain range, the strength of the vicinity of the surface is increased to provide a positive electrode active material particle with less deterioration. For example, a lithium oxide and a fluoride are mixed and heated to form a positive electrode active material particle.

When a portion where pure LiCoO₂ is exposed exists on the surface of the positive electrode active material particle, projections and depressions are generated and cobalt or oxygen is deintercalated at the time of charge and discharge to break the crystal structure, thereby causing deterioration. In order not to expose, on the surface, a portion where the pure LiCoO₂ is exposed, it is preferable to uniformly cover the surface with a compound including magnesium. Magnesium has a function of maintaining the crystal structure (layered rock-salt crystal structure) when Li is deintercalated at the time of discharge. The magnesium (or fluorine) existing in the vicinity of the surface of the positive electrode active material particle is also one of the features.

With the above structure, even when pressure is applied to a positive electrode including the positive electrode active material in manufacturing a secondary battery, a crack is less likely to be generated and the shape of the particle can be maintained. This can cause less excess cracks to increase the electrode density.

In the case where surface unevenness is larger than the above range and the surface is rough, a crack and breakage of the crystal structure might be caused physically. With the breakage of the crystal structure, a portion where pure LiCoO₂ is exposed might be exposed on the surface to accelerate deterioration.

As the lithium oxide, a material with a layered rock-salt crystal structure is preferable; a composite oxide represented by LiMO₂ is given, for example. As an example of the element M, one or more elements selected from Co and Ni can be given. As another example of the element M, in addition to one or more elements selected from Co and Ni, one or more elements selected from Al and Mg can be given.

When fluorine is included in the vicinity of the surface, not only fluorine but also magnesium, aluminum, and nickel can be put in the vicinity of the surface at high concentrations. The fluorine is inhibited from diffusing outward as a gas during annealing while covered with a lid, and the other elements such as aluminum diffuse into the solid material. The fluorine improves the wettability of the surface of the positive electrode active material, so that the surface is homogenized.

The composite oxide containing lithium, the transition metal, and oxygen preferably has a layered rock-salt crystal structure with few defects and distortions. Therefore, the composite oxide is preferably a composite oxide with few impurities. In the case where the composite oxide containing lithium, the transition metal, and oxygen includes a large amount of impurities, the crystal structure is highly likely to have a large number of defects or distortions.

In order that no impurity is included, it is preferable to perform heating with the lid put on after the fluoride is mixed to conduct surface modification of the positive electrode active material. The timing of putting the lid is any one of the following: the lid is put so as to cover the container before heating, and then the container is placed in a heating furnace; the container is placed on the furnace, and then the lid is put so as to cover the container; the lid is put during heating before the fluoride is melted.

### [Structure of Positive Electrode Active Material]

A material with a layered rock-salt crystal structure, such as lithium cobalt oxide (LiCoO₂), is known to have a high discharge capacity and excel as a positive electrode active material of a secondary battery. As an example of the material with a layered rock-salt crystal structure, a composite oxide represented by LiMO₂ is given. As an example of the element M, one or more selected from Co and Ni can be given. As another example of the element M, in addition to one or more elements selected from Co and Ni, one or more elements selected from Al and Mg can be given.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when high-voltage charge and discharge are performed on LiNiO₂, the crystal structure might be broken because of the distortion. The influence of the Jahn-Teller effect is suggested to be small in LiCoO₂; hence, LiCoO₂ is preferable because the resistance to high-voltage charge and discharge is higher in some cases.

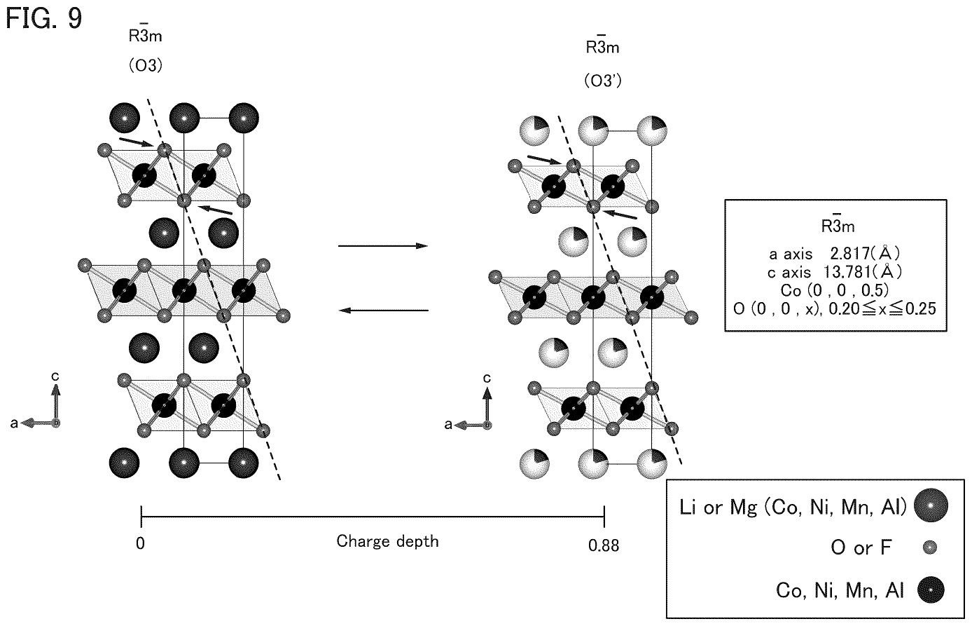

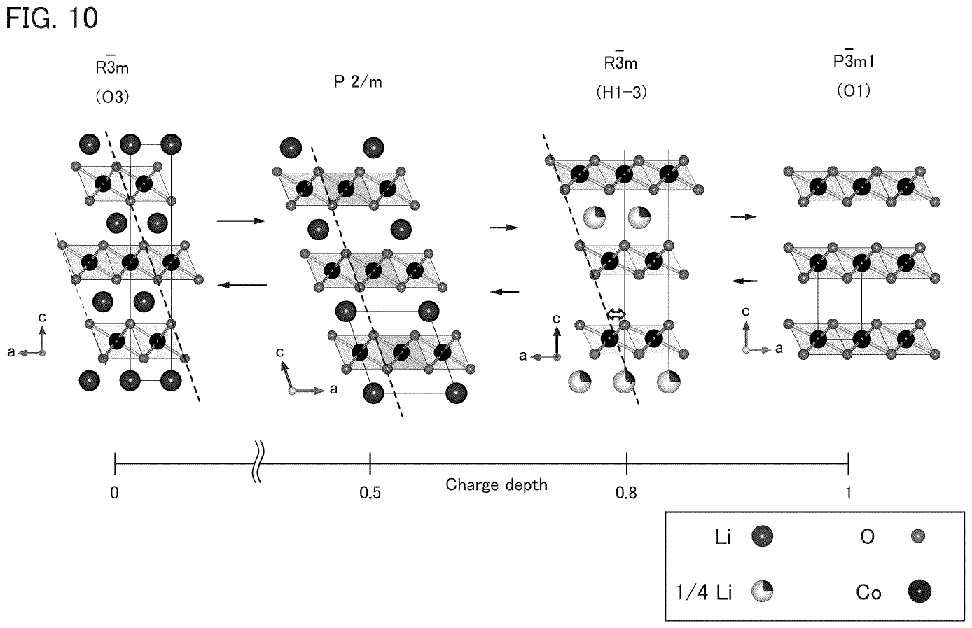

The positive electrode active material is described with reference to FIG. 9 and FIG. 10. In FIG. 9 and FIG. 10, the case where cobalt is used as a transition metal contained in the positive electrode active material is described.

In the positive electrode active material formed by one embodiment of the present invention, the difference in the positions of CoO₂ layers can be small in repeated charge and discharge at high voltage. Furthermore, the change in the volume can be small. Accordingly, the positive electrode active material of one embodiment of the present invention can achieve excellent cycle performance. In addition, the positive electrode active material of one embodiment of the present invention can have a stable crystal structure in a high-voltage charging state. Thus, in the positive electrode active material of one embodiment of the present invention, a short circuit is less likely to occur while the high-voltage charging state is maintained. This is preferable because the safety is further improved.

The positive electrode active material of one embodiment of the present invention has a small change in the crystal structure and a small difference in volume per the same number of transition metal atoms between a sufficiently discharging state and a high-voltage charging state.

FIG. 9 illustrates the crystal structures of a positive electrode active material of one embodiment of the present invention before and after being charged and discharged. The positive electrode active material of one embodiment of the present invention is a composite oxide including lithium, cobalt, and oxygen. In addition to the above, the positive electrode active material preferably includes magnesium. Furthermore, the positive electrode active material preferably includes halogen such as fluorine or chlorine. The positive electrode active material preferably contains aluminum and nickel.

The crystal structure with a charge depth of 0 (in the discharged state) in FIG. 9 is R-3m (O3) as in FIG. 10. Meanwhile, the positive electrode active material illustrated in FIG. 10 with a charge depth in a sufficiently charged state includes a crystal whose structure is different from the H1-3 type structure (the space group R-3m). This structure belongs to the space group R-3m, and is not a spinel crystal structure but a structure in which oxygen is hexacoordinated to ions of cobalt, magnesium, or the like and the cation arrangement has symmetry similar to that of the spinel crystal structure. Furthermore, the symmetry of CoO₂ layers of this structure is the same as that in the O3 type structure. Accordingly, this structure is referred to as an O3′ type crystal structure or a pseudo-spinel crystal structure in this specification and the like. Note that although lithium exists in any of lithium sites at an approximately 20% probability in the diagram of the O3′ type crystal structure illustrated in FIG. 9, the structure is not limited thereto. Lithium may exist in only some certain lithium sites. In addition, in both the O3 type crystal structure and the O3′ type crystal structure, a slight amount of magnesium preferably exists between the CoO₂ layers, i.e., in lithium sites. In addition, a slight amount of halogen such as fluorine preferably exists in oxygen sites at random.

Note that in the O3′ type crystal structure, oxygen is tetracoordinated to a light element such as lithium in some cases; also in that case, the ion arrangement has symmetry similar to that of the spinel structure.

The O3′ type crystal structure can also be regarded as a crystal structure that includes Li between layers at random but is similar to a CdCl₂ type crystal structure. The crystal structure similar to the CdCl₂ type crystal structure is close to a crystal structure of lithium nickel oxide when charged up to a charge depth of 0.94 (Li_{0.06}NiO₂); however, pure lithium cobalt oxide or a layered rock-salt positive electrode active material containing a large amount of cobalt is known not to have this crystal structure in general.

Anions of a layered rock-salt crystal and anions of a rock-salt crystal have a cubic close-packed structure (face-centered cubic lattice structure). Anions of a pseudo-spinel-type crystal are also presumed to have a cubic close-packed structure. When the pseudo-spinel-type crystal is in contact with the layered rock-salt crystal and the rock-salt crystal, there is a crystal plane at which orientations of cubic close-packed structures composed of anions are aligned. Note that a space group of the layered rock-salt crystal and the O3′ type crystal structure is R-3m, which is different from a space group Fm-3m of a rock-salt crystal (a space group of a general rock-salt crystal) and a space group Fd-3m of a rock-salt crystal (a space group of a rock-salt crystal having the simplest symmetry); thus, the Miller index of the crystal plane satisfying the above conditions in the layered rock-salt crystal and the O3′ type crystal structure is different from that in the rock-salt crystal. In this specification, a state where the orientations of the cubic close-packed structures composed of anions in the layered rock-salt crystal, the O3′ type crystal structure, and the rock-salt crystal are aligned is sometimes referred to as a state where crystal orientations are substantially aligned.

In the positive electrode active material of one embodiment of the present invention, a change in the crystal structure when the positive electrode active material is charged with high voltage and a large amount of lithium is extracted is inhibited as compared with a comparative example described later. As shown by dotted lines in FIG. 9, for example, CoO₂ layers hardly deviate in the crystal structures.

More specifically, the structure of the positive electrode active material of one embodiment of the present invention is highly stable even when a charge voltage is high. For example, an H1-3 type structure is formed at a voltage of approximately 4.6 V with the potential of a lithium metal as the reference in the comparative example; however, the positive electrode active material of one embodiment of the present invention can maintain the crystal structure of R-3m (O3) even at the voltage of approximately 4.6 V. Even at higher charge voltages, e.g., a voltage of approximately 4.65 V to 4.7 V with the potential of a lithium metal as the reference, the positive electrode active material of one embodiment of the present invention can have the O3′ type crystal structure. At a charge voltage increased to be higher than 4.7 V, an H1-3 type crystal may be finally observed in the positive electrode active material of one embodiment of the present invention. In addition, the positive electrode active material of one embodiment of the present invention might have the O3′ type structure even at a lower charge voltage (e.g., a charge voltage of greater than or equal to 4.5 V and less than 4.6 V with the potential of a lithium metal as the reference). Note that in the case where graphite is used as a negative electrode active material in a secondary battery, for example, the voltage of the secondary battery is lower than the above-mentioned voltages by the potential of graphite. The potential of graphite is approximately 0.05 V to 0.2 V with reference to the potential of a lithium metal. Thus, even in a secondary battery which includes graphite as a negative electrode active material and which has a voltage of greater than or equal to 4.3 V and less than or equal to 4.5 V, for example, the positive electrode active material of one embodiment of the present invention can maintain the crystal structure belonging to R-3m (O3) and moreover, can have the O3′ type structure at higher voltages, e.g., a voltage of the secondary battery of greater than 4.5 V and less than or equal to 4.6 V. In addition, the positive electrode active material of one embodiment of the present invention can have the O3′ type structure at lower charge voltages, e.g., at a voltage of the secondary battery of greater than or equal to 4.2 V and less than 4.3 V, in some cases.

Thus, in the positive electrode active material of one embodiment of the present invention, the crystal structure is less likely to be broken even when charge and discharge are repeated at high voltage.

In addition, in the positive electrode active material of one embodiment of the present invention, a difference in the volume per unit cell between the O3-type crystal structure with a charge depth of 0 and the pseudo-spinel crystal structure with a charge depth of 0.8 is less than or equal to 2.5%, specifically, less than or equal to 2.2%. In the unit cell of the O3′ type crystal structure, coordinates of cobalt and oxygen can be represented by Co (0, 0, 0.5) and O (0, 0, x) within the range of 0.20≤x≤0.25.

A slight amount of additive substances, such as magnesium, existing between the CoO₂ layers, i.e., in lithium sites at random, has an effect of inhibiting a deviation in the CoO₂ layers in high-voltage charging. Thus, when magnesium exists between the CoO₂ layers, the O3′ type crystal structure is likely to be formed.

However, cation mixing occurs when the heat treatment temperature is excessively high, so that magnesium is highly likely to enter the cobalt sites. Magnesium in the cobalt sites does not have an effect of maintaining the R-3m structure in high-voltage charging in some cases. Furthermore, when the heat treatment temperature is excessively high, adverse effects such as reduction of cobalt to have a valence of two and transpiration of lithium are concerned.

In view of the above, a halogen compound such as a fluorine compound is preferably added to lithium cobalt oxide before the heat treatment for distributing magnesium over whole particles. The addition of the halogen compound depresses the melting point of lithium cobalt oxide. The depression of the melting point makes it easier to distribute magnesium over whole particles at a temperature at which the cation mixing is unlikely to occur. Furthermore, it is expected that the existence of the fluorine compound can improve corrosion resistance to hydrofluoric acid generated by decomposition of an electrolyte solution.

When the magnesium concentration is higher than a predetermined value, the effect of stabilizing a crystal structure becomes small in some cases. This is probably because magnesium enters the cobalt sites in addition to the lithium sites. The number of magnesium atoms in the positive electrode active material formed by one embodiment of the present invention is preferably 0.001 times or more and 0.1 times or less, further preferably more than 0.01 times and less than 0.04 times, still further preferably approximately 0.02 times as large as the number of cobalt atoms. The magnesium concentration described here may be a value obtained by element analysis on the entire particles of the positive electrode active material using ICP-MS or the like, or may be a value based on the ratio of the raw materials mixed in the forming process of the positive electrode active material, for example.

The number of nickel atoms in the positive electrode active material of one embodiment of the present invention is preferably 7.5% or lower, preferably 0.05% or higher and 4% or lower, further preferably 0.1% or higher and 2% or lower of the number of cobalt atoms. The nickel concentration described here may be a value obtained by element analysis on the entire particle of the positive electrode active material using ICP-MS or the like, or may be a value based on the ratio of the raw materials mixed in the forming process of the positive electrode active material, for example.

### <<Particle Diameter>>

A too large particle diameter of the positive electrode active material of one embodiment of the present invention causes problems such as difficulty in lithium diffusion and too much surface roughness of an active material layer in coating to a current collector. By contrast, a too small particle diameter causes problems such as difficulty in carrying the active material layer in coating to the current collector and overreaction with an electrolyte solution. Therefore, an average particle diameter (D50, also referred to as median diameter) is preferably more than or equal to 1 μm and less than or equal to 100 μm, further preferably more than or equal to 2 μm and less than or equal to 40 μm, still further preferably more than or equal to 5 μm and less than or equal to 30 μm.

### <Analysis Method>

Whether or not a positive electrode active material has the pseudo-spinel-type crystal structure when charged with high voltage can be determined by analyzing a high-voltage charged positive electrode using XRD, electron diffraction, neutron diffraction, electron spin resonance (ESR), nuclear magnetic resonance (NMR), or the like. The XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode obtained by disassembling a secondary battery can be measured without any change with sufficient accuracy, for example.

As described so far, the positive electrode active material has a feature of a small change in the crystal structure between the high-voltage charged state and the discharged state. A material where 50 wt % or more of the crystal structure largely changes between the high-voltage charged state and the discharged state is not preferable because the material cannot withstand the high-voltage charge and discharge. In addition, it should be noted that an objective crystal structure is not obtained in some cases only by addition of impurity elements. For example, although the positive electrode active material that is lithium cobaltate containing magnesium and fluorine is a commonality, the positive electrode active material has 60 wt % or more of the pseudo-spinel-type crystal structure in some cases, and has 50 wt % or more of the H1-3 type crystal structure in other cases, when charged with a high voltage. Furthermore, at a predetermined voltage, the positive electrode active material has almost 100 wt % of the pseudo-spinel-type crystal structure, and with an increase in the predetermined voltage, the H1-3 type crystal structure is generated in some cases. Thus, the crystal structure of the positive electrode active material is preferably analyzed by XRD or the like. The combination of the analysis methods and measurement such as XRD enables more detail analysis.

Note that a positive electrode active material in the high-voltage charged state or the discharged state sometimes causes a change in the crystal structure when exposed to air. For example, the pseudo-spinel-type crystal structure changes into the H1-3 type crystal structure in some cases. Thus, all samples are preferably handled in an inert atmosphere such as an atmosphere including argon.

### Comparative Example

A positive electrode active material illustrated in FIG. 10 is lithium cobalt oxide (LiCoO₂) to which halogen or magnesium is not added in a manufacturing method described later. The crystal structure of the lithium cobalt oxide illustrated in FIG. 10 is changed depending on a charge depth.

As illustrated in FIG. 10, lithium cobalt oxide with a charge depth of 0 (discharged state) includes a region having a crystal structure of the space group R-3m, and includes three C002 layers in a unit cell. Thus, this crystal structure is referred to as an O3 type crystal structure in some cases. Note that the CoO₂ layer has a structure in which octahedral geometry with oxygen hexacoordinated to cobalt continues on a plane in the edge-sharing state.

When the charge depth is 1, LiCoO₂ has the crystal structure of the space group P-3 ml, and one CoO₂ layer exists in a unit cell. Thus, this crystal structure is referred to as an 01 type crystal structure in some cases.

Moreover, lithium cobalt oxide with a charge depth of approximately 0.8 has the crystal structure of the space group R-3m. This structure can also be regarded as a structure in which CoO₂ structures such as P-3 ml (O1) and LiCoO₂ structures such as R-3m (O3) are alternately stacked. Thus, this crystal structure is referred to as an H1-3 type crystal structure in some cases. Note that the number of cobalt atoms per unit cell in the actual H1-3 type crystal structure is twice as large as that of cobalt atoms per unit cell in other structures. However, in this specification including FIG. 10, the c-axis of the H1-3 type crystal structure is half that of the unit cell for easy comparison with the other structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O₁ and O₂ are each an oxygen atom. In this manner, the H1-3 type crystal structure is represented by a unit cell including one cobalt and two oxygen. Meanwhile, the O3′ type crystal structure of one embodiment of the present invention is preferably represented by a unit cell including one cobalt and one oxygen. This means that the symmetry of cobalt and oxygen differs between the O3′ type crystal structure and the H1-3 type structure, and the amount of change from the O3 structure is smaller in the O3′ type crystal structure than in the H1-3 type structure. A preferred unit cell for representing a crystal structure in a positive electrode active material is selected such that the value of GOF (good of fitness) is smaller in the Rietveld analysis of XRD, for example.

When charge with a high voltage of 4.6 V or higher based on the redox potential of a lithium metal or charge with a large charge depth of 0.8 or more and discharge are repeated, the crystal structure of lithium cobalt oxide changes (i.e., an unbalanced phase change occurs) repeatedly between the H1-3 type crystal structure and the R-3m (O3) structure in a discharged state.

However, there is a large deviation in the position of the CoO₂ layer between these two crystal structures. As indicated by dotted lines and an arrow in FIG. 10, the CoO₂ layer in the H1-3 type crystal structure greatly shifts from that in the R-3m (O3) structure. Such a dynamic structural change might adversely affect the stability of the crystal structure.

A difference in volume is also large. The H1-3 type crystal structure and the O3 type crystal structure in a discharged state that contain the same number of cobalt atoms have a difference in volume of 3.0% or more.

In addition, a structure in which CoO₂ layers are continuous, such as P-3 ml (O1), included in the H1-3 type crystal structure is highly likely to be unstable.

Thus, the repeated high-voltage charge and discharge break the crystal structure of lithium cobalt oxide. The break of the crystal structure degrades the cycle performance. This is probably because the break of the crystal structure reduces sites where lithium can stably exist and makes it difficult to insert and extract lithium.

### <Surface Roughness and Specific Surface Area>

The positive electrode active material of one embodiment of the present invention preferably has a smooth surface with little unevenness. A smooth surface with little unevenness indicates favorable distribution of the additive in the vicinity of the surface.

A smooth surface with little unevenness can be recognized from, for example, a cross-sectional SEM image or a cross-sectional TEM image of the positive electrode active material or the specific surface area of the positive electrode active material.

The level of the surface smoothness of the positive electrode active material can be quantified from its cross-sectional SEM image, as described below, for example.

First, the positive electrode active material is processed with an FIB or the like such that its cross section is exposed. At this time, the positive electrode active material is preferably covered with a protective film, a protective agent, or the like. Next, a SEM image of the interface between the positive electrode active material and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material and the protective film or the like is selected with a magic hand tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square (RMS) surface roughness is obtained by calculating standard deviation. This surface roughness refers to the surface roughness of part of the particle periphery (at least 400 nm) of the positive electrode active material.

On the surface of the particle of the positive electrode active material of this embodiment, roughness which is an index of roughness (RMS: root-mean-square surface roughness) is preferably less than 3 nm, further preferably less than 1 nm, still further preferably less than 0.5 nm.

Note that the image processing software used for the noise processing, the interface extraction, or the like is not particularly limited, and “ImageJ” can be used, for example. In addition, the spreadsheet software or the like is not particularly limited, and Microsoft Office Excel can be used, for example.

For example, the level of surface smoothness of the positive electrode active material can also be quantified from the ratio of an actual specific surface area A_{R} measured by a constant-volume gas adsorption method to an ideal specific surface area Aᵢ.

The ideal specific surface area Aᵢ is calculated on the assumption that all the particles have the same diameter as D50, have the same weight, and have ideal spherical shapes.

The median diameter D50 can be measured with a particle size distribution analyzer or the like using a laser diffraction and scattering method. The specific surface area can be measured with a specific surface area analyzer or the like by a constant-volume gas adsorption method, for example.

In the positive electrode active material of one embodiment of the present invention, the ratio A_{R}/Aᵢ of the actual specific surface area A_{R} to the ideal specific surface area Aᵢ obtained from the median diameter D50 is preferably less than or equal to 2.

This embodiment can be implemented in appropriate combination with the other embodiments.

### Embodiment 4

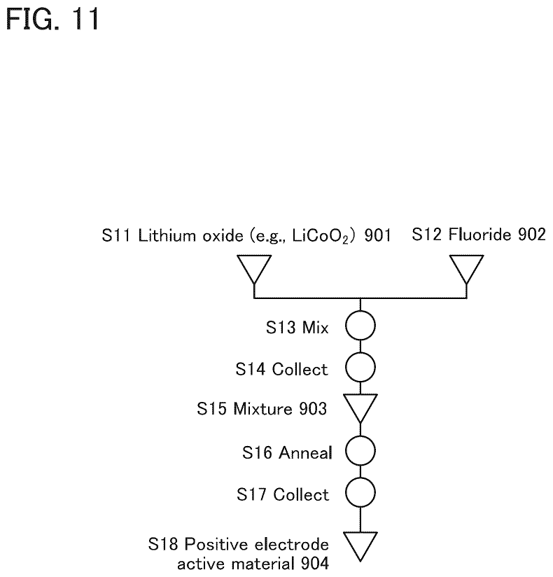

An example of a method for manufacturing LiMO₂ (M is two or more kinds of metals including Co, and the substitution positions of the metals are not particularly limited) is described with reference to FIG. 11. A positive electrode active material containing Mg as a metal element contained in LiMO₂ other than Co is described below as an example. Note that the positive electrode active material of one embodiment of the present invention has a crystal structure of a lithium composite oxide represented by LiMO₂, but the composition is not strictly limited to Li:M:O=1:1:2.

As a material for a lithium oxide 901, a composite oxide including lithium, a transition metal, and oxygen is used.

In the case where a composite oxide containing lithium, a transition metal, and oxygen that is synthesized in advance is used, a composite oxide with few impurities is preferably used. In this specification and the like, lithium, cobalt, nickel, manganese, aluminum, and oxygen are the main components of the composite oxide containing lithium, a transition metal, and oxygen and the positive electrode active material, and elements other than the main components are regarded as impurities. For example, when analyzed with a glow discharge mass spectroscopy method, the total impurity concentration is preferably less than or equal to 10000 wt ppm, further preferably less than or equal to 5000 wt ppm. In particular, the total impurity concentration of transition metals such as titanium and arsenic is preferably less than or equal to 3000 wt ppm, further preferably less than or equal to 1500 wt ppm.

For example, as the lithium cobalt oxide synthesized in advance, a lithium cobalt oxide particle (product name: CELLSEED C-10N) formed by NIPPON CHEMICAL INDUSTRIAL CO., LTD. can be used. This is lithium cobalt oxide in which the average particle diameter (D50) is approximately 12 μm, and in the impurity analysis by a glow discharge mass spectroscopy method (GD-MS), the magnesium concentration and the fluorine concentration are less than or equal to 50 wt ppm, the calcium concentration, the aluminum concentration, and the silicon concentration are less than or equal to 100 wt ppm, the nickel concentration is less than or equal to 150 wt ppm, the sulfur concentration is less than or equal to 500 wt ppm, the arsenic concentration is less than or equal to 1100 wt ppm, and the concentrations of elements other than lithium, cobalt, and oxygen are less than or equal to 150 wt ppm.

The lithium oxide 901 in Step S11 preferably has a layered rock-salt crystal structure with few defects and distortions. Therefore, the composite oxide is preferably a composite oxide with few impurities. In the case where the composite oxide containing lithium, the transition metal, and oxygen includes a large number of impurities, the crystal structure is highly likely to have a large number of defects or distortions.

Furthermore, a fluoride 902 for Step S12 is prepared. In this embodiment, a lithium fluoride (LiF) is prepared as the fluoride 902. LiF is preferable because it has a cation common with LiCoO₂. LiF, which has a relatively low melting point of 848° C., is preferable because it is easily melted in an annealing process described later. MgF₂ may be used in addition to LiF. Fluorides that can be used in one embodiment of the present invention are not limited to LiF and MgF₂.

In addition, it is acceptable which Step S11 or Step S12 is performed first.

Next, mixing and grinding are performed in Step S13. Although the mixing can be performed by a dry process or a wet process, the wet process is preferable because the materials can be ground to a smaller size. When the mixing is performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, acetone is used.

For example, a ball mill, a bead mill, or the like can be used for the mixing. When the ball mill is used, a zirconia ball can be used as media, for example. The mixing and grinding steps are preferably performed sufficiently to pulverize a mixture 903.

The materials mixed and ground in the above manner are collected (Step S14 in FIG. 11), whereby the mixture 903 is obtained (Step S15 in FIG. 11).

For example, the D50 of the mixture 903 is preferably greater than or equal to 600 nm and less than or equal to 20 μm, further preferably greater than or equal to 1 μm and less than or equal to 10 μm.

Then, the mixture 903 is heated (Step S16 in FIG. 11). This step is referred to as annealing in some cases. LiMO₂ is produced by the annealing. Thus, the conditions of performing Step S16, such as temperature, time, an atmosphere, or weight of the mixture 903 to be annealed, are important. The meaning of annealing in this specification, includes a case where the mixture 903 is heated and a case where a heating furnace in which at least the mixture 903 is placed is heated. The heating furnace in this specification is equipment used for performing heat treatment (annealing) on a substance or a mixture and includes a heater unit, an atmosphere including a fluoride, and an inner wall that can withstand at least 600° C. Furthermore, the heating furnace may be provided with a pump having a function of reducing and/or increasing the inside pressure of the heating furnace. For example, pressure may be applied during the annealing in S16.

The annealing temperature in S16 is further preferably higher than or equal to the temperature at which the mixture 903 melts. The annealing temperature needs to be lower than or equal to a decomposition temperature of LiCoO₂ (1130° C.). Since the decomposition temperature of LiCoO₂ is 1130° C., decomposition of a slight amount of LiCoO₂ is concerned at a temperature close to the decomposition temperature. Thus, the annealing temperature is preferably lower than or equal to 1130° C., and is preferably lower than or equal to 1000° C.

LiF is used as the fluoride 902 and the annealing in S16 is conducted with the lid put on, whereby a positive electrode active material 904 with favorable cycle characteristics and the like can be manufactured. It is considered that when LiF and MgF₂ are used as the fluoride 902, the reaction with LiCoO₂ is promoted with the annealing temperature in S16 set to be higher than or equal to 742° C. to generate LiMO₂ because the eutectic point of LiF and MgF₂ is around 742° C.

Furthermore, an endothermic peak of LiF, MgF₂, and LiCoO₂ is observed at around 820° C. by differential scanning calorimetry (DSC measurement). Thus, the annealing temperature is preferably higher than or equal to 742° C., further preferably higher than or equal to 820° C.

Accordingly, the annealing temperature is preferably higher than or equal to 742° C. and lower than or equal to 1130° C., further preferably higher than or equal to 742° C. and lower than or equal to 1000° C. Moreover, the annealing temperature is preferably higher than or equal to 820° C. and lower than or equal to 1130° C., further preferably higher than or equal to 820° C. and lower than or equal to 1000° C.

In this embodiment, LiF, which is a fluoride, is considered to function as flux. Accordingly, since the capacity of the heating furnace is larger than the capacity of the container and LiF is lighter than oxygen, it is expected that LiF is volatilized and the reduction of LiF in the mixture 903 inhibits production of LiMO₂. Therefore, heating needs to be performed while volatilization of LiF is inhibited.

Thus, when the mixture 903 is heated in an atmosphere including LiF, that is, the mixture 903 is heated in a state where the partial pressure of LiF in the heating furnace is high, volatilization of LiF in the mixture 903 is inhibited. By performing annealing using the fluoride (LiF or MgF) to form an eutectic mixture with the lid put on, the annealing temperature can be lowered to the decomposition temperature of the LiCoO₂ (1130° C.) or lower, specifically, a temperature higher than or equal to 742° C. and lower than or equal to 1000° C., thereby enabling the production of LiMO₂ to progress efficiently. Accordingly, a positive electrode active material having favorable characteristics can be formed, and the annealing time can be reduced.

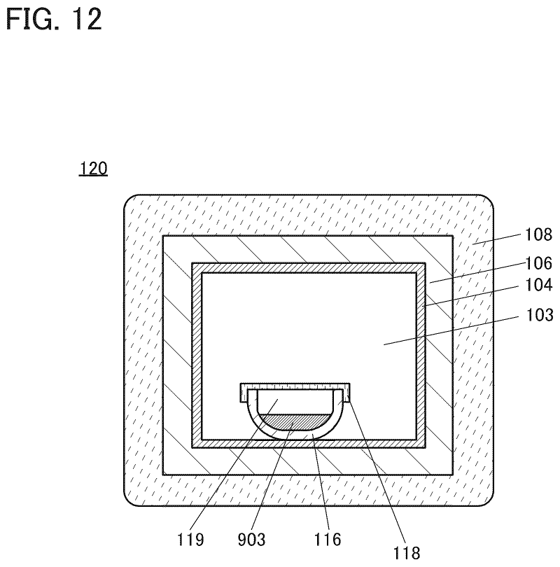

FIG. 12 illustrates an example of the annealing method in S16.

A heating furnace 120 illustrated in FIG. 12 includes a space 103 in the heating furnace, a hot plate 104, a heater unit 106, and a heat insulator 108. It is further preferable to put a lid 118 on a container 116 in annealing. With this structure, an atmosphere including a fluoride can be obtained in a space 119 enclosed by the container 116 and the lid 118. In the annealing, the state of the space 119 is maintained with the lid put on so that the concentration of the gasified fluoride inside the space 119 can be constant or cannot be reduced, in which case fluorine or magnesium can be contained in the vicinity of the particle surface. The atmosphere including a fluoride can be provided in the space 119, which is smaller in capacity than the space 103 in the heating furnace, by volatilization of a smaller amount of a fluoride. This means that an atmosphere including a fluoride can be provided in the reaction system without a significant reduction in the amount of a fluoride included in the mixture 903. Accordingly, LiMO₂ can be produced efficiently. In addition, the use of the lid 118 allows the annealing of the mixture 903 in an atmosphere including a fluoride to be simply and inexpensively performed.

Furthermore, the fluoride or the like attached to inner walls of the container 116 and the lid 118 is likely to be fluttered again by the heating and attached to the mixture 903.

Here, the valence number of Co (cobalt) in LiMO₂ formed by one embodiment of the present invention is preferably approximately 3. The valence number of cobalt can be 2 or 3. Thus, to inhibit reduction of cobalt, it is preferable that the atmosphere in the space 103 in the heating furnace include oxygen, the ratio of oxygen to nitrogen in the atmosphere in the space 103 in the heating furnace be higher than or equal to that in the air atmosphere, and the oxygen concentration in the atmosphere in the space 103 in the heating furnace be higher than or equal to that in the air atmosphere. Thus, an atmosphere including oxygen needs to be introduced into the space in the heating furnace

Thus, in one embodiment of the present invention, before heating is performed, a step of providing an atmosphere including oxygen in the space 103 in the heating furnace and a step of placing the container 116 in which the mixture 903 is placed in the space 103 in the heating furnace are performed. The steps in this order enable the mixture 903 to be annealed in an atmosphere including oxygen and a fluoride. During the annealing, the space 103 in the heating furnace is preferably sealed to prevent any gas from being discharged to the outside. For example, it is preferable that no gas flows during the annealing.

Although there is no particular limitation on the method of providing an atmosphere including oxygen in the space 103 in the heating furnace, examples are a method of introducing an oxygen gas or a gas containing oxygen such as dry air after exhausting air from the space 103 in the heating furnace and a method of flowing an oxygen gas or a gas containing oxygen such as dry air into the space 103 for a certain period of time. In particular, introducing an oxygen gas after exhausting air from the space 103 in the heating furnace (oxygen displacement) is preferred. Note that the atmosphere of the space 103 in the heating furnace may be regarded as an atmosphere including oxygen.

There is no particular limitation on the step of heating the heating furnace 120. The heating may be performed using a heating mechanism included in the heating furnace 120.

Although there is no particular limitation on the way of placing the mixture 903 in the container 116, as illustrated in FIG. 12, the mixture 903 is preferably provided so that the top surface of the mixture 903 is flat on the bottom surface of the container 116, in other words, the level of the top surface of the mixture 903 becomes uniform.

The annealing in Step S16 is preferably performed at an appropriate temperature for an appropriate time. The appropriate temperature and time change depending on the conditions such as the particle size and the composition of the particle of the lithium oxide 901 in Step S11. In the case where the particle size is small, the annealing is preferably performed at a lower temperature or for a shorter time than the case where the particle size is large, in some cases. After the annealing in S16, a step of removing the lid is performed.

For example, in the case where the average particle diameter (D50) of particles in Step S11 is approximately 12 μm, the annealing time is preferably 3 hours or longer, further preferably 10 hours or longer.

By contrast, in the case where the average particle diameter (D50) of particles in Step S11 is approximately 5 μm, the annealing time is preferably longer than or equal to 1 hour and shorter than or equal to 10 hours, further preferably approximately 2 hours, for example.

The temperature decreasing time after the annealing is, for example, preferably longer than or equal to 10 hours and shorter than or equal to 50 hours.

The materials annealed in the above manner are collected (Step S17 in FIG. 11), whereby the positive electrode active material 904 is obtained (Step S18 in FIG. 11).

Here, in the annealing in S16, the difference between a particle obtained by annealing using the lid and a particle obtained by annealing without using the lid, which is a comparative example, is described next.

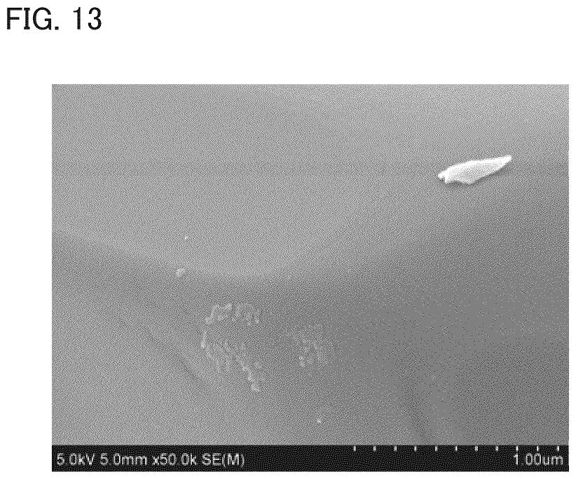

FIG. 13 shows an example of a cross-sectional image of one of the positive electrode active material particles subjected to annealing using the lid, which is obtained with a SEM.

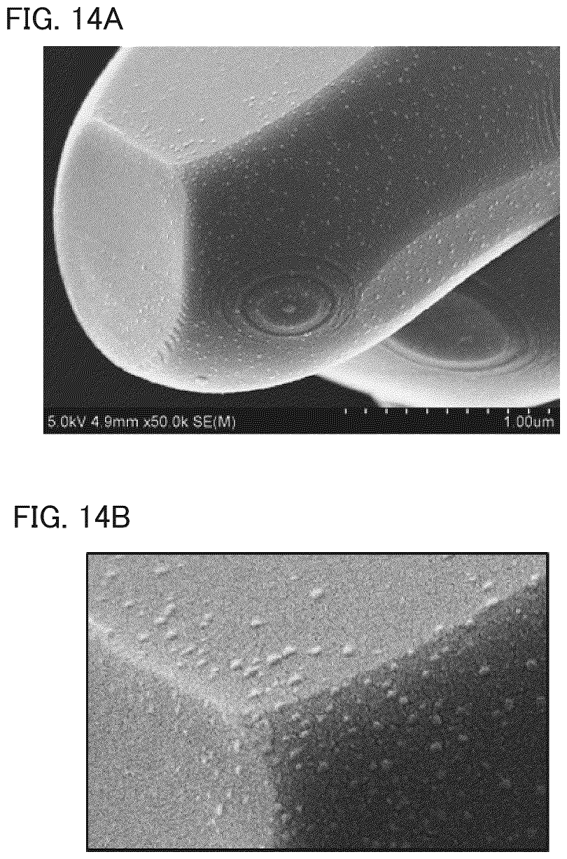

FIG. 14B is an enlarged view of a part of FIG. 14A that is the comparative example. It is found that the surface of the particle in FIG. 13 is smoother than that in FIG. 14A and FIG. 14B.

This embodiment can be implemented in appropriate combination with the other embodiments.

### Embodiment 5

In this embodiment, an example of manufacturing a battery cell using LiMO₂ formed by the manufacturing method of one embodiment of the present invention will be described. Since many parts are common, a manufacturing method thereof is described with reference to FIG. 11.

Lithium cobalt oxide is prepared as the oxide 901. Specifically, CELLSEED C-10N manufactured by NIPPON CHEMICAL INDUSTRIAL CO., LTD. is prepared (Step S11).

LiF and MgF₂ are prepared for the fluoride 902 (Step S12). LiF and MgF₂ are weighted so that the molar ratio of LiF to MgF₂ is LiF:MgF₂=1:3, acetone is added as a solvent, and the materials are mixed and ground by a wet process. LiF to lithium cobalt oxide is set to 0.17 mol %. MgF₂ to lithium cobalt oxide is set to 0.5 mol %.

The lithium oxide 901 and the fluoride 902 are mixed (Step S13) and collected (Step S14) to give the mixture 903 (Step S15).

Then, the mixture 903 is put in a container and a lid is put on the container. The inside of the heating furnace is set to an oxygen atmosphere and annealing is performed (Step S16). The annealing temperature might be different depending on the weight of the mixture 903, but is preferably higher than or equal to 742° C. and less than or equal to 1000° C. An annealing temperature is a temperature at the time of the annealing, and “annealing time” is time for holding the annealing temperature. The temperature rising rate is 200° C./h, and the temperature decreasing time is longer than or equal to 10 hours. It is preferable that the space 103 in the heating furnace be sealed during the annealing to prevent any gas from being discharged to the outside. For example, it is preferable that no gas flows during the annealing.

In this embodiment, the annealing temperature of 850° C., 60 hours, and an oxygen atmosphere in the heating furnace are employed.

After the annealing, the positive electrode active material 904 can be collected (Step S18). When a surface without unevenness is obtained, the lid may be removed during the heating for cooling. After the cooling, the lid is removed and the obtained positive electrode active material 904 is used to form each positive electrode. A current collector that is coated with slurry in which the positive electrode active material, AB, and PVDF are mixed at the active material: AB:PVDF=95:3:2 (weight ratio) is used. As a solvent of the slurry, NMP is used.

After the current collector is coated with the slurry, the solvent is volatilized. Then, pressure is applied. Through the above process, the positive electrode can be obtained.

Using the formed positive electrodes, CR2032 type coin battery cells (a diameter of 20 mm, a height of 3.2 mm) are formed.

A lithium metal is used for a counter electrode.

As an electrolyte included in the electrolyte solution, 1 mol/L lithium hexafluorophosphate (LiPF₆) is used. As the electrolyte solution, an electrolyte solution in which ethylene carbonate (EC) and diethyl carbonate (DEC) are mixed at EC:DEC=3:7 (volume ratio) is used. Note that 2 wt % vinylene carbonate (VC) is added to the electrolyte solution.

As a separator, 25-μm-thick polypropylene is used.

A positive electrode can and a negative electrode can that are formed using stainless steel (SUS) are used.

Through the above steps, a secondary battery cell can be manufactured.

The comparison results of experiments conducted under different annealing conditions are shown below.

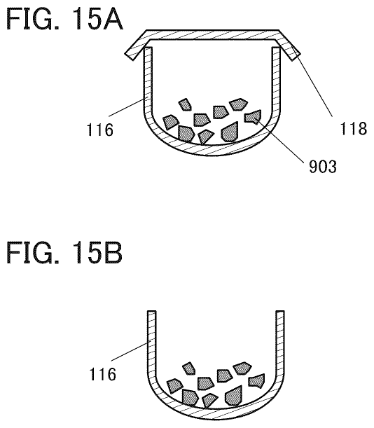

FIG. 15A illustrates a condition that is the same as the above-described manufacturing method and is the same as FIG. 12, using the same reference numerals in FIG. 12. The same material, specifically, a ceramics material, is used for the container and the lid. The lid is larger than the opening of the container, and the lid is set by its self-weight. No gap is preferred between the lid and the container as much as possible, but the lid has a gap to prevent the inside of the container from being airtight with the lid.

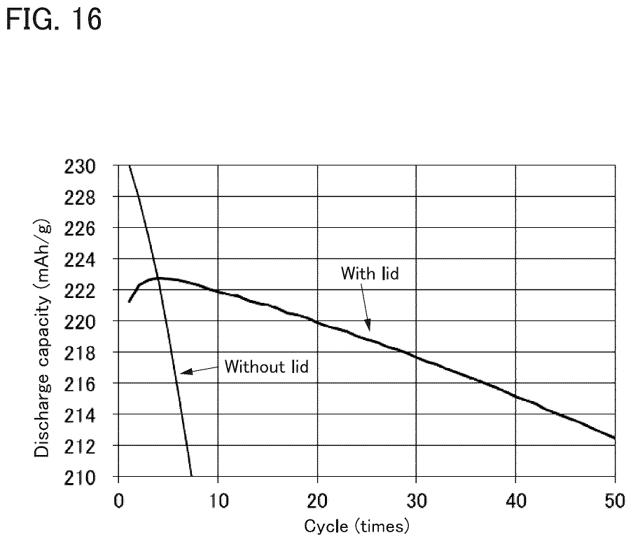

FIG. 16 shows cycle characteristics of the battery cell. The cycle characteristics were evaluated at 25° C. while the CCCV charging (0.5 C, 4.6 V, termination current of 0.05 C) and the CC discharging (0.5 C, 2.5 V) were performed. FIG. 16 shows the results.

FIG. 16 also shows cycle characteristics of a battery cell manufactured by the same manufacturing procedure under the same conditions except that a lid is put not as illustrated in FIG. 15B, as a comparative example.

From the above, it can be confirmed that the condition for the annealing using a lid shows favorable cycle characteristics compared with the comparative example under the annealing condition without using a lid.

This embodiment can be implemented in appropriate combination with the other embodiments.

### Embodiment 6

In this embodiment, examples of the shape of a secondary battery including the positive electrode active material manufactured by the manufacturing method described in the above embodiment are described. For the materials used for the secondary battery described in this embodiment, the description of the above embodiment can be referred to.

### [Coin-Type Secondary Battery]

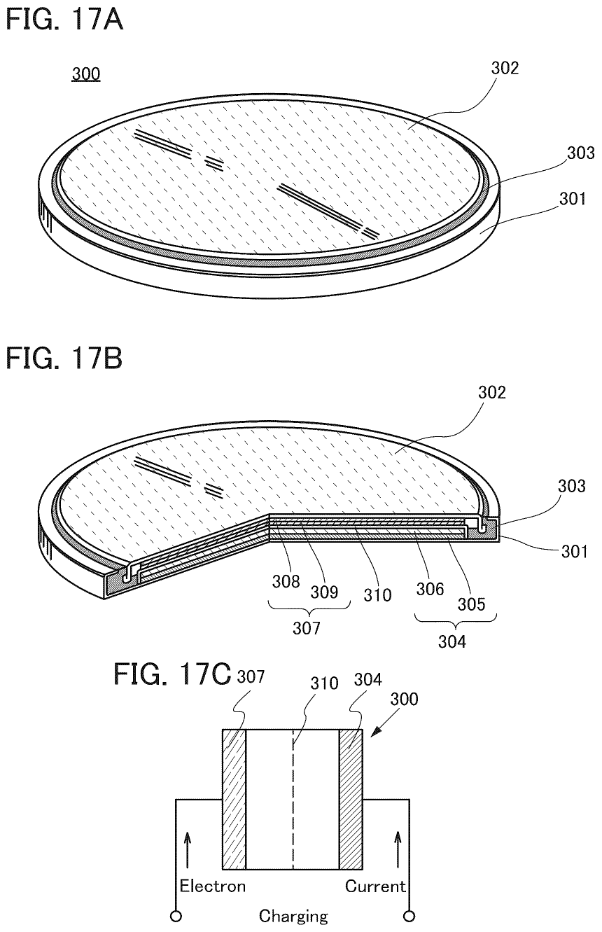

An example of a coin-type secondary battery is described. FIG. 17A is an external view of a coin-type (single-layer flat type) secondary battery, and FIG. 17B is a cross-sectional view thereof.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. Alternatively, the positive electrode can 301 and the negative electrode can 302 are preferably covered with nickel, aluminum, or the like in order to prevent corrosion due to the electrolyte solution. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and a separator 310 are immersed in the electrolyte solution; as illustrated in FIG. 17B, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

When the positive electrode active material particle described in the above embodiments is used in the positive electrode 304, the coin-type secondary battery 300 with little deterioration and high safety can be obtained.

### [Separator]

The secondary battery preferably includes a separator. As the separator, for example, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably formed to have an envelope-like shape to wrap one of the positive electrode and the negative electrode.

The separator may have a multilayer structure. For example, an organic material film such as polypropylene or polyethylene can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

Deterioration of the separator in high-voltage charge and discharge can be inhibited and thus the reliability of the secondary battery can be improved because oxidation resistance is improved when the separator is coated with the ceramic-based material. In addition, when the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of the polypropylene film that is in contact with the positive electrode may be coated with the mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

Here, a current flow in charging a secondary battery is described with reference to FIG. 17C. When a secondary battery using lithium is regarded as a closed circuit, lithium ions transfer and a current flows in the same direction. Note that in a secondary battery using lithium, the anode and the cathode are interchanged in charging and discharging, and the oxidation reaction and the reduction reaction are interchanged; thus, an electrode with a high reaction potential is called the positive electrode and an electrode with a low reaction potential is called the negative electrode. For this reason, in this specification, the positive electrode is referred to as a “positive electrode” or a “plus electrode” and the negative electrode is referred to as a “negative electrode” or a “minus electrode” in all the cases where charge is performed, discharge is performed, a reverse pulse current is supplied, and a charge current is supplied. The use of terms such as anode and cathode related to oxidation reaction and reduction reaction might cause confusion because the anode and the cathode are reversed in charging and in discharging. Thus, the terms such as anode and cathode are not used in this specification. If the term such as an anode or a cathode is used, whether it is at the time of charge or discharge is noted and whether it corresponds to a positive electrode or a negative electrode is also noted.

Two terminals illustrated in FIG. 17C are connected to a charger, and the secondary battery 300 is charged. As the charge of the secondary battery 300 proceeds, a potential difference between electrodes increases.

### [Cylindrical Secondary Battery]

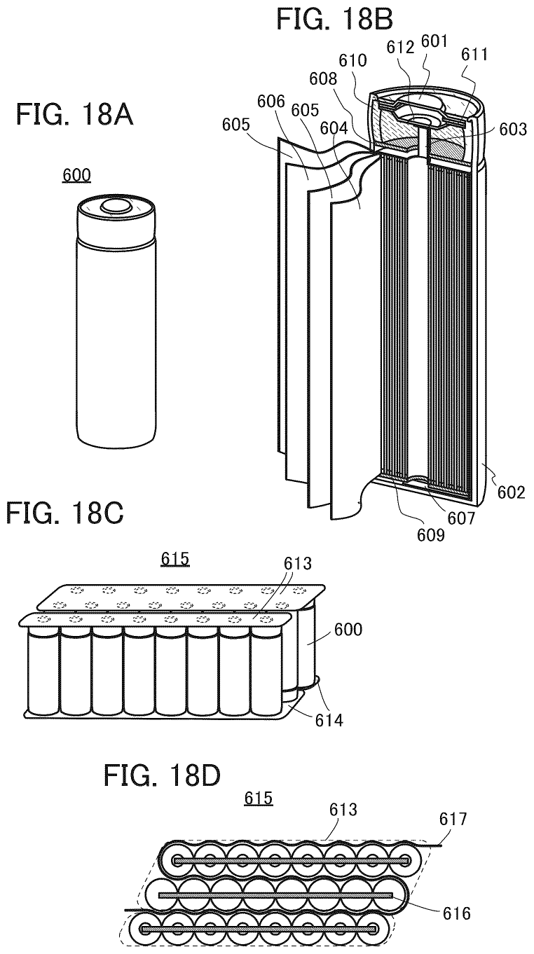

An example of a cylindrical secondary battery is described with reference to FIG. 18A to FIG. 18D. As illustrated in FIG. 18A, the cylindrical secondary battery 600 includes a positive electrode cap (battery lid) 601 on a top surface and a battery can (outer can) 602 on a side surface and a bottom surface. The positive electrode cap and the battery can (outer can) 602 are insulated from each other by a gasket (insulating gasket) 610.

FIG. 18B is a schematic cross-sectional view of a cylindrical secondary battery. Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a center pin. One end of the battery can 602 is closed and the other end thereof is opened. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel or aluminum, for example, in order to prevent corrosion due to the electrolyte solution. Inside the battery can 602, the battery element in which the positive electrode, the negative electrode, and the separator are wound is provided between a pair of insulating plates 608 and 609 that face each other. Furthermore, the inside of the battery can 602 provided with the battery element is filled with a nonaqueous electrolyte solution (not illustrated). As the nonaqueous electrolyte solution, an electrolyte solution similar to that for the coin-type secondary battery can be used.

Since a positive electrode and a negative electrode that are used for a cylindrical storage battery are wound, active materials are preferably formed on both surfaces of a current collector. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a PTC (positive temperature coefficient) element 611. The safety valve mechanism 612 cuts off electrical connection between the positive electrode cap 601 and the positive electrode 604 when the internal pressure of the battery exceeds a predetermined threshold value. In addition, the PTC element 611 is a thermally sensitive resistor whose resistance increases as temperature rises, and limits the amount of current by increasing the resistance to prevent abnormal heat generation. Barium titanate (BaTiO₃)-based semiconductor ceramics or the like can be used for the PTC element.

As illustrated in FIG. 18C, a plurality of secondary batteries 600 may be provided between a conductive plate 613 and a conductive plate 614 to form a module 615. The plurality of secondary batteries 600 may be connected in parallel, connected in series, or connected in series after being connected in parallel. With the module 615 including the plurality of secondary batteries 600, large electric power can be extracted.

FIG. 18D is a top view of the module 615. The conductive plate 613 is shown by a dotted line for clarity of the drawing. As illustrated in FIG. 18D, the module 615 may include a conductive wire 616 electrically connecting the plurality of secondary batteries 600 with each other. The conductive plate can be provided over the conductive wire 616 to overlap the conductive wire 616. In addition, a temperature control device 617 may be provided between the plurality of secondary batteries 600. The secondary batteries 600 can be cooled with the temperature control device 617 when overheated, whereas the secondary batteries 600 can be heated with the temperature control device 617 when cooled too much. Thus, the performance of the module 615 is less likely to be influenced by the outside temperature.

When the positive electrode active material formed by the forming method described in the above embodiment is used in the positive electrode 604, the cylindrical secondary battery 600 with little deterioration and high safety can be obtained.

### [Structure Examples of Secondary Battery]

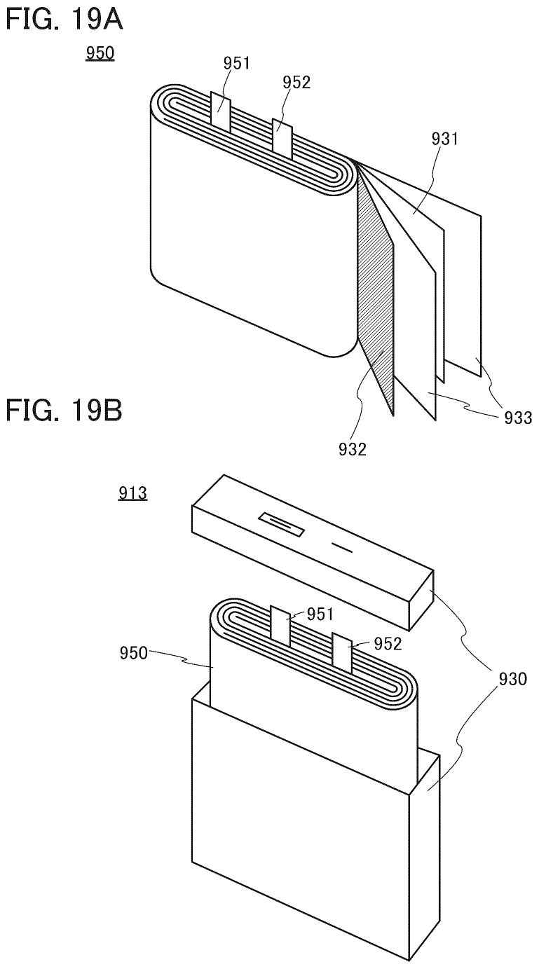

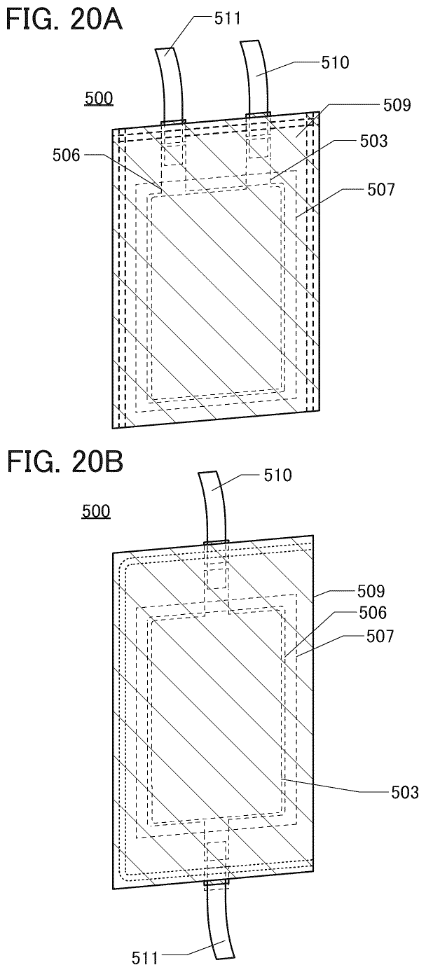

Other structural examples of power storage devices will be described with reference to FIG. 19 and FIG. 20.

FIG. 19A illustrates a structure of a wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks of the negative electrode 931, the positive electrode 932, and the separator 933 may be further overlaid.

The secondary battery 913 illustrated in FIG. 19B includes a wound body 950 provided with the terminal 951 and the terminal 952 inside a housing 930. The wound body 950 is immersed in an electrolyte solution inside the housing 930. The terminal 952 is in contact with the housing 930. The terminal 951 is not in contact with the housing 930 with use of an insulator or the like. Note that in FIG. 19B, the housing 930 that has been divided is illustrated for convenience; however, in reality, the wound body 950 is covered with the housing 930, and the terminal 951 and the terminal 952 extend to the outside of the housing 930. For the housing 930, a metal material (e.g., aluminum) or a resin material can be used.

### [Laminated Secondary Battery>

Next, an example of a laminated secondary battery is described with reference to FIG. 20A and FIG. 20B.

FIG. 20A illustrates an example of an external view of a laminated secondary battery 500. FIG. 20B illustrates another example of an external view of the laminated secondary battery 500.

In FIG. 20A and FIG. 20B, the positive electrode 503, the negative electrode 506, the separator 507, the exterior body 509, a positive electrode lead electrode 510, and a negative electrode lead electrode 511 are included.

The laminated secondary battery 500 includes a wound body or a plurality of positive electrodes 503, separators 507, and negative electrodes 506 that are each strip-shaped.

The wound body includes the negative electrode 506, the positive electrode 503, and the separator 507. The wound body is, like the wound body illustrated in FIG. 19A, obtained by winding a sheet of a stack in which the negative electrode 506 overlaps with the positive electrode 503 with the separator 507 provided therebetween.

The secondary battery may include the plurality of positive electrodes 503, separators 507, and negative electrodes 506 that are each strip-shaped in a space formed by a film serving as the exterior body 509.

A manufacturing method of the secondary battery including the plurality of positive electrodes 503, separators 507, and negative electrodes 506 that are each strip-shaped is described below.

First, the negative electrodes 506, the separators 507, and the positive electrodes 503 are stacked. This embodiment describes an example using five negative electrodes and four positive electrodes. Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

After that, the negative electrodes 506, the separators 507, and the positive electrodes 503 are placed over the exterior body 509.

As the exterior body 509, for example, a laminate film having a three-layer structure can be employed in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

The exterior body 509 is folded to interpose the stack therebetween. Then, the outer edges of the exterior body 509 are bonded to each other. The bonding can be performed by thermocompression, for example. In this bonding, an unbonded region (hereinafter referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert gas atmosphere. Lastly, the inlet is sealed by bonding. In the above manner, the laminated secondary battery 500 can be manufactured.

When the positive electrode active material particle described in the above embodiment is used in the positive electrode 503, the secondary battery 500 with little deterioration and high safety can be obtained.

This embodiment can be implemented in appropriate combination with the other embodiments.

### Embodiment 7

In this embodiment, a structure of a solid secondary battery will be described. In this specification, not only a secondary battery including only a solid electrolyte but also a secondary battery including a polymer gel electrolyte, a few amount of electrolyte, or a combination thereof is also referred to as a solid battery.

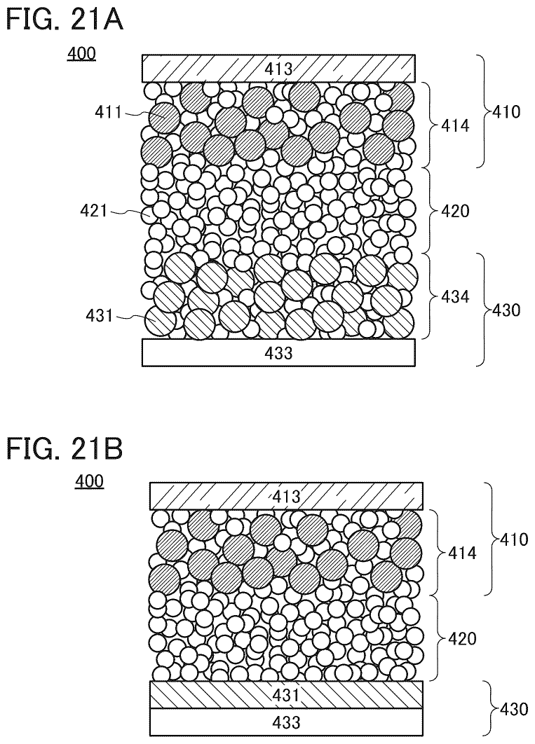

As illustrated in FIG. 21A, a secondary battery 400 that is the solid battery of one embodiment of the present invention includes a positive electrode 410, a solid electrolyte layer 420, and a negative electrode 430. FIG. 21A illustrates a case of using a solid electrolyte. When the solid electrolyte is used, a separator and a spacer are not necessary. Furthermore, the battery can be entirely solidified; therefore, there is no possibility of liquid leakage and thus the safety is dramatically increased.

The positive electrode 410 includes a positive electrode current collector 413 and a positive electrode active material layer 414. The positive electrode active material layer 414 includes a positive electrode active material 411 and a solid electrolyte 421. As the positive electrode active material 411, the positive electrode active material 904 described in the above embodiment can be used. The positive electrode active material layer 414 may also include a conductive agent and a binder. As the conductive agent, a carbon material such as carbon black (e.g., acetylene black (AB)), graphite (black lead) particles, carbon nanotubes (CNT), or fullerene can be used. Alternatively, metal powder or metal fibers of copper, nickel, aluminum, silver, gold, or the like, a conductive ceramic material, or the like can be used. Alternatively, a graphene compound may be used as the conductive agent. A graphene compound has excellent electrical characteristics of high conductivity and excellent physical properties of high flexibility and high mechanical strength in some cases. A graphene compound has a planar shape. A graphene compound enables low-resistance surface contact. Furthermore, a graphene compound has extremely high conductivity even with a small thickness in some cases and thus allows a conductive path to be formed in an active material layer efficiently even with a small amount. Hence, a graphene compound is preferably used as a conductive additive, in which case the area where the active material and the conductive additive are in contact with each other can be increased. In addition, a graphene compound is preferable because electrical resistance can be reduced in some cases. Here, examples of the graphene compound include graphene, multilayer graphene, multi graphene, graphene oxide, multilayer graphene oxide, multi graphene oxide, graphene oxide that is reduced, multilayer graphene oxide that is reduced, multi graphene oxide that is reduced, and graphene quantum dots. The graphene oxide that is reduced is also referred to as reduced graphene oxide (hereinafter RGO). Note that RGO refers to a compound obtained by reducing graphene oxide (GO), for example. In the case where an active material particle with a small particle diameter, e.g., 1 μm or less, is used, the specific surface area of the active material particle is large and thus more conductive paths for connecting the active material particles are needed. In such a case, a graphene compound that can efficiently form a conductive path even in a small amount is particularly preferably used. In this specification and the like, graphene oxide contains carbon and oxygen, has a sheet-like shape, and includes a functional group, in particular, an epoxy group, a carboxy group, or a hydroxy group. When a plurality of graphene compounds are bonded to each other, a net-like graphene compound sheet (hereinafter referred to as a graphene compound net or a graphene net) can be formed. The graphene net covering the active material can function as a binder for bonding active materials. The amount of binder can thus be reduced, or the binder does not have to be used. This can increase the proportion of the active material in the electrode volume or the electrode weight. That is, the capacity of the secondary battery can be increased.

The solid electrolyte layer 420 includes the solid electrolyte 421. The solid electrolyte layer 420 is positioned between the positive electrode 410 and the negative electrode 430, and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive agent and a binder. Note that when metal lithium is used for the negative electrode 430, it is possible that the negative electrode 430 does not include the solid electrolyte 421 as illustrated in FIG. 21B. The use of metallic lithium for the negative electrode 430 is preferable because the energy density of the secondary battery 400 can be increased. Note that in FIG. 21A and FIG. 21B, the solid electrolyte 421, the positive electrode active material 411, and the negative electrode active material 431 have spherical shapes as ideal particle shapes; however, they actually have various shapes, and thus the shapes are schematically illustrated in the drawings for convenience.

As materials for the solid electrolyte 421 included in the solid electrolyte layer 420 and the solid electrolyte layer 420, a sulfide-based solid electrolyte, an oxide-based solid electrolyte, or a halide-based solid electrolyte can be used, for example.

Examples of the sulfide-based solid electrolyte include a thio-silicon-based material (e.g., Li₁₀GeP₂Si₂ and Li_{3.25}Ge_{0.25}P_{0.75}S₄), sulfide glass (e.g., 70Li₂S·30P₂S₅, 30Li₂S·26B₂S₃·44LiI, 63Li₂S·38SiS₂·1Li₃PO₄, 57Li₂S·38SiS₂·5Li₄SiO₄, and 50Li₂S·50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a conduction path after charge and discharge because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1-X}Al_{X}Ti_{2-X}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Note that in this specification and the like, a material with a NASICON crystal structure refers to a compound that is represented by M₂(XO₄)₃ (M: transition metal; X: S, P, As, Mo, W, or the like) and has a structure in which MO₆ octahedra and XO₄ tetrahedra that share common corners are arranged three-dimensionally.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

Alternatively, an electrolyte solution may be mixed.

As the electrolyte solution that is mixed with a solid electrolyte, an electrolyte solution that is highly purified and contains small numbers of dust particles and elements other than the constituent elements of the electrolyte solution (hereinafter also simply referred to as “impurities”) is preferably used. Specifically, the weight ratio of impurities to the electrolyte solution is preferably less than or equal to 1%, further preferably less than or equal to 0.1%, still further preferably less than or equal to 0.01%.

An additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution that is mixed with the solid electrolyte. The concentration of a material to be added in the whole solvent is, for example, higher than or equal to 0.1 wt % and lower than or equal to 5 wt %.

As the material mixed with the solid electrolyte, a polymer gel electrolyte obtained in such a manner that a polymer is swelled with an electrolyte solution may be used.

When a polymer gel electrolyte is used, safety against liquid leakage and the like is improved. Furthermore, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

This embodiment can be implemented in appropriate combination with the other embodiments.

### Embodiment 8

In this embodiment, examples of electronic devices or a vehicle each using the secondary battery of one embodiment of the present invention will be described.

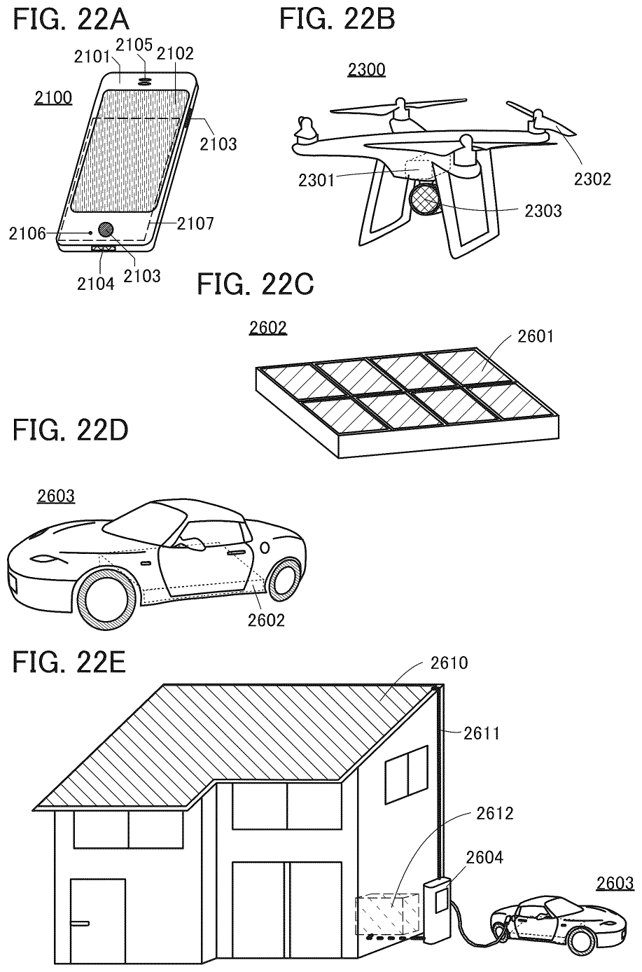

First, FIG. 22A to FIG. 22E show examples of electronic devices each including the secondary battery described in the above embodiment. Examples of electronic devices each including the bendable secondary battery include television devices (also referred to as televisions or television receivers), monitors for computers and the like, digital cameras, digital video cameras, digital photo frames, mobile phones (also referred to as cellular phones or mobile phone devices), portable game machines, portable information terminals, audio reproducing devices, and large game machines such as pachinko machines.

The secondary battery can also be used in moving vehicles, typically automobiles. Examples of the automobiles include next-generation clean energy vehicles such as hybrid vehicles (HVs), electric vehicles (EVs), and plug-in hybrid vehicles (PHVs), and the secondary battery can be used as one of the power sources provided for the automobiles. Furthermore, the moving object is not limited to an automobile. Examples of moving vehicles include a train, a monorail train, a ship, and a flying object (a helicopter, an unmanned aircraft (a drone), an airplane, and a rocket), electric vehicles, and electric motorcycles, and the secondary battery of one embodiment of the present invention can be used for the moving vehicles.

The secondary battery of this embodiment may be used in a ground-based charging apparatus provided for a house or a charging station provided in a commerce facility.

FIG. 22A illustrates an example of a mobile phone. A mobile phone 2100 includes a display portion 2102 installed in a housing 2101, an operation button 2103, an external connection port 2104, a speaker 2105, a microphone 2106, and the like. Note that the mobile phone 2100 includes a secondary battery 2107.

The mobile phone 2100 is capable of executing a variety of applications such as mobile phone calls, e-mailing, viewing and editing texts, music reproduction, Internet communication, and computer games.

With the operation button 2103, a variety of functions such as time setting, power on/off operation, wireless communication on/off operation, execution and cancellation of a silent mode, and execution and cancellation of a power saving mode can be performed. For example, the functions of the operation button 2103 can also be set freely by an operating system incorporated in the mobile phone 2100.

In addition, the mobile phone 2100 can execute near field communication conformable to a communication standard. For example, by mutual communication between the mobile phone 2100 and a headset capable of wireless communication, hands-free calling can be performed.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 22B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. The secondary battery of one embodiment of the present invention is preferable as a secondary battery mounted on the unmanned aircraft 2300 because it has a high level of safety and thus can be used safely for a long time over a long period.

Furthermore, as illustrated in FIG. 22C, a secondary battery 2602 including a plurality of secondary batteries 2601 of one embodiment of the present invention may be mounted on a hybrid electric vehicle (HV), an electric vehicle (EV), a plug-in hybrid electric vehicle (PHV), or another electronic device.

FIG. 22D illustrates an example of a vehicle including the secondary battery 2602. A vehicle 2603 is an electric vehicle that runs using an electric motor as a power source. Alternatively, the vehicle 2603 is a hybrid electric vehicle that can appropriately select an electric motor or an engine as a driving power source. The vehicle 2603 using the electric motor includes a plurality of ECUs (Electronic Control Units) and performs engine control by the ECUs. The ECU includes a microcomputer. The ECU is connected to a CAN (Controller Area Network) provided in the electric vehicle. The CAN is a type of a serial communication standard used as an in-vehicle LAN. The secondary battery of one embodiment of the present invention can be used to function as a power source of ECU and a vehicle with a high level of safety and a long cruising range can be achieved.

The secondary battery not only drives the electric motor (not illustrated) but also can supply electric power to a light-emitting device such as a headlight or a room light. Furthermore, the secondary battery can supply electric power to a display device and a semiconductor device included in the vehicle 2603, such as a speedometer, a tachometer, and a navigation system.

In the vehicle 2603, the secondary batteries included in the secondary battery 2602 can be charged by being supplied with electric power from external charging equipment by a plug-in system, a contactless power feeding system, or the like.

FIG. 22E illustrates a state in which the vehicle 2603 is supplied with electric power from ground-based charging equipment 2604 through a cable. In charging, a given method such as CHAdeMO (registered trademark) or Combined Charging System may be employed as a charging method, the standard of a connector, or the like as appropriate. For example, with a plug-in technique, the secondary battery 2602 incorporated in the vehicle 2603 can be charged by being supplied with electric power from the outside. Charging can be performed by converting AC power into DC power through a converter such as an ACDC converter. The charging equipment 2604 may be provided for a house as illustrated in FIG. 22E, or may be a charging station provided in a commercial facility.

Although not illustrated, the vehicle can include a power receiving device so as to be charged by being supplied with power from an above-ground power transmitting device in a contactless manner. In the case of the contactless power feeding system, by fitting a power transmitting device in a road or an exterior wall, charging can be performed not only when the vehicle is stopped but also when driven. In addition, this contactless power feeding system may be utilized to transmit and receive power between vehicles. Furthermore, a solar cell may be provided in the exterior of the vehicle to charge the secondary battery when the vehicle stops or moves. To supply power in such a contactless manner, an electromagnetic induction method or a magnetic resonance method can be used.

The house illustrated in FIG. 22E includes a power storage system 2612 including the secondary battery of one embodiment of the present invention and a solar panel 2610. The power storage system 2612 is electrically connected to the solar panel 2610 through a wiring 2611 or the like. The power storage system 2612 may be electrically connected to the ground-based charging equipment 2604. The power storage system 2612 can be charged with electric power generated by the solar panel 2610. The secondary battery 2602 included in the vehicle 2603 can be charged with the electric power stored in the power storage system 2612 through the charging equipment 2604.

The electric power stored in the power storage system 2612 can also be supplied to other electronic devices in the house. Thus, with the use of the power storage system 2612 of one embodiment of the present invention as an uninterruptible power source, electronic devices can be used even when electric power cannot be supplied from a commercial power source due to power failure or the like.

This embodiment can be implemented in appropriate combination with the other embodiments.

### Example 1

In this example, a secondary battery including reduced graphene oxide as a conductive agent and a secondary battery including acetylene black were fabricated and their characteristics were evaluated.

### <Fabrication of Secondary Batteries>

For evaluation, CR2032 type coin secondary batteries (a diameter of 20 mm, a height of 3.2 mm) were fabricated.

As a positive electrode active material in the secondary battery, lithium nickel-cobalt-manganese oxide with Ni:Co:Mn=5:2:3 (atomic ratio) (produced by MTI) was used. This is referred to as NCM523 in some cases.

As a conductive agent, graphene oxide (GO) or acetylene black (AB) was used. The graphene oxide is reduced in a later step. The composition proportion of the graphene oxide in the total amount of the active material, the graphene oxide, and a binder was set to 3 wt %.

As the binder, PVDF was used.

The positive electrode active material, the conductive agent, and the binder were mixed to form slurry. NMP was used as a solvent. The slurry was applied to a current collector and dried. As the current collector, an aluminum foil with a carbon undercoat was used.

Next, the sample using the graphene oxide as a conductive agent was subjected to chemical reduction and thermal reduction.

As a reducing agent for chemical reduction, L-ascorbic acid was used. As a solvent, a solution containing 0.078 mol/L of L-ascorbic acid and 0.074 mol/L of lithium hydroxide was formed by mixing water and NMP at a volume ratio of 1:9. The current collector coated with a positive electrode active material layer was immersed in the L-ascorbic acid solution and reacted at 60° C. for one hour.

Next, thermal reduction was performed at 170° C. for 10 hours.

After the reduction treatment, application of linear pressure at 210 kN/m was performed and then application of linear pressure at 1467 kN/m was performed, whereby positive electrodes were fabricated.

A lithium metal was used for a counter electrode.

As an electrolyte contained in an electrolyte solution, 1 mol/L lithium hexafluorophosphate (LiPF₆) was used. As the electrolyte solution, a solution in which ethylene carbonate (EC) and diethyl carbonate (DEC) were mixed at a volume ratio of 3:7 and 2 wt % vinylene carbonate (VC) was added thereto was used.

As a separator, 25-μm-thick polypropylene was used.

A positive electrode can and a negative electrode can that were formed using stainless steel (SUS) were used.

### <Battery Characteristics>

Next, the fabricated samples were subjected to a charge and discharge test.

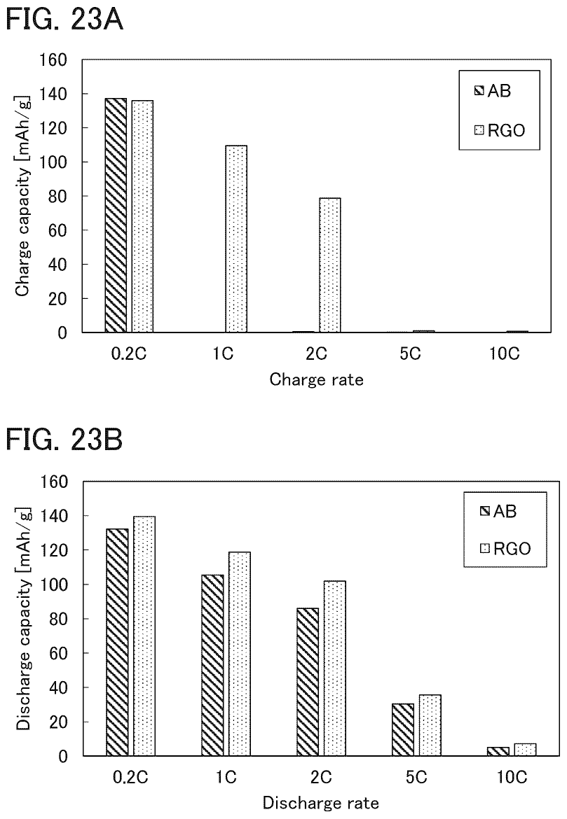

FIG. 23A shows charge rate characteristics at 0° C. FIG. 23B shows discharge rate characteristics at 0° C. The CC charging (0.2 C, 1 C, 2 C, 5 C, or 10 C, a termination voltage of 4.3 V) and the CC discharging (0.2 C, 1 C, 2 C, 5 C, or 10 C, a termination voltage of 2.0 V) were performed. Note that 1 C was set to 170 mA/g in this example and the like.

The sample using the reduced graphene oxide as a conductive agent (denoted by RGO in the drawing) exhibited more favorable high rate characteristics than the sample using the acetylene black (denoted by AB in the drawing).

### Example 2

For evaluation, CR2032 type coin secondary batteries (a diameter of 20 mm, a height of 3.2 mm) were fabricated.

As a positive electrode active material in the secondary battery, lithium nickel-cobalt-manganese oxide with Ni:Co:Mn=5:2:3 (atomic ratio) (produced by MTI) was used.

As a conductive agent, graphene oxide (GO) or acetylene black (AB) was used. The graphene oxide is reduced in a later step. The composition proportion of the graphene oxide in the total amount of the active material, the graphene oxide, and a binder was set to 1 wt□ or 3 wt %.

As the binder, PVDF was used. The composition proportion of the binder in the total amount of the active material, the graphene oxide, and the binder was set to 2 wt %.

For formation of slurry and reduction of the graphene oxide, the conditions described in Example 1 were used.

After the reduction treatment, application of linear pressure at 210 kN/m was performed and then application of linear pressure at 1467 kN/m was performed, whereby positive electrodes were fabricated. The carried amount of the positive electrode was approximately 7 mg/cm².

As a counter electrode, an electrolyte solution, a separator, a positive electrode can, and a negative electrode can, those described in Example 1 were used.

The cycle characteristics of the fabricated secondary batteries were evaluated. The measurement temperature was set to 60° C. As charge, CC charging was performed at 1 C with a termination voltage of 4.3 V and then CV charging was performed under termination conditions of 0.1 C and 1.5 hours with 4.3 V. As discharge, CC discharging was performed at 1 C with a termination voltage of 2.5 V.

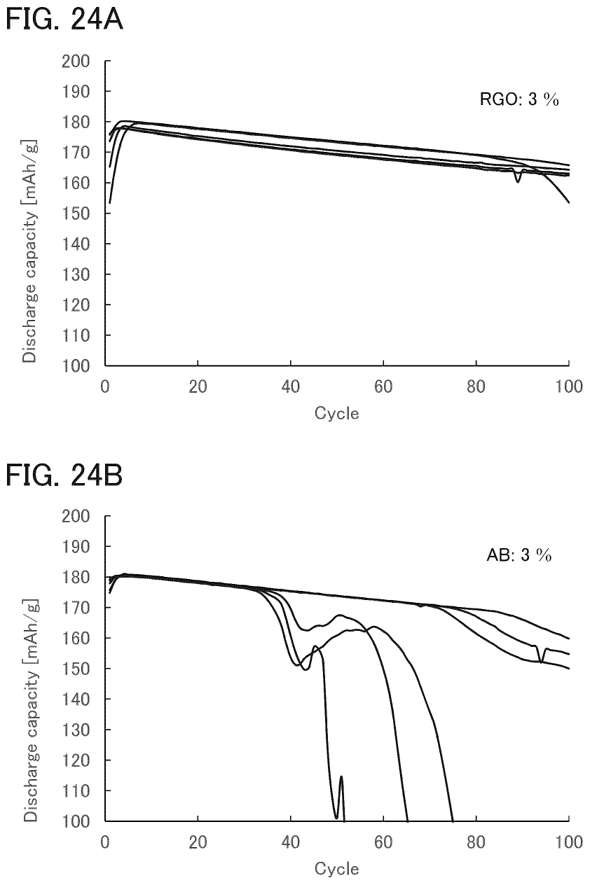

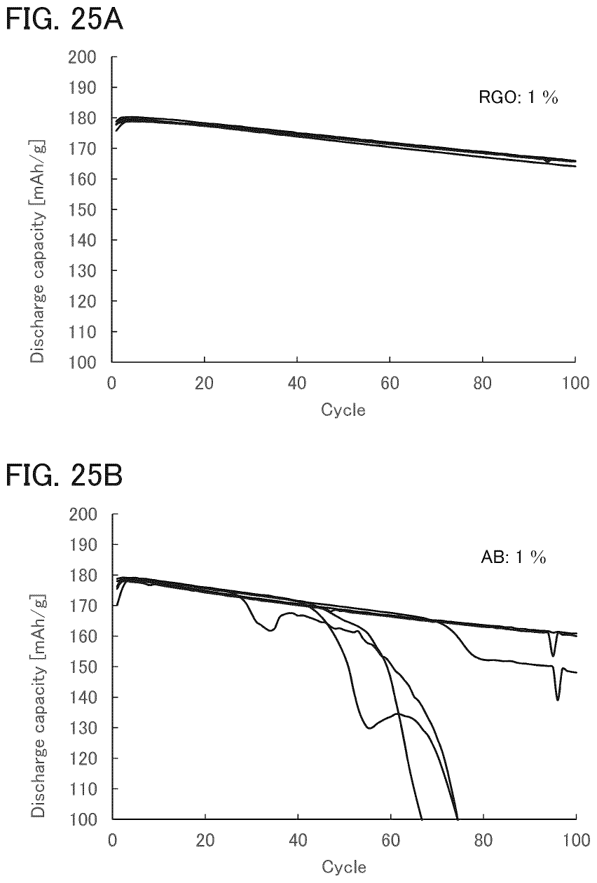

FIG. 24A shows the measurement results of the samples each using the graphene oxide at 3 wt□ as a conductive agent (represented as RGO: 3 □ in the drawing) and FIG. 24B shows the measurement results of the samples each using the acetylene black at 3 wt□ as a conductive agent (represented as AB: 3 □ in the drawing). FIG. 25A shows the measurement results of the samples each using the graphene oxide at 1 wt□ as a conductive agent (represented as RGO: 1 □ in the drawing) and FIG. 25B shows the measurement results of the samples each using the acetylene black at 1 wt□ as a conductive agent (represented as AB: 1 □ in the drawing).

In the sample using the reduced graphene oxide as a conductive agent, variation in the characteristics was reduced and a sudden decrease in capacity due to cycles was suppressed than in the sample using the acetylene black.

### Example 3

In this example, a laminated secondary battery was fabricated and a change in its volume was evaluated.

### <Fabrication of Negative Electrodes>

MCMB graphite having a specific surface area of 1.5 m²/g was used and mixed with a conductive agent, CMC-Na (carboxymethyl cellulose), and SBR at the graphite:the conductive agent:CMC-Na:SBR=96:1:1:2 (weight ratio) using water as a solvent, whereby slurry was formed.

The polymerization degree of CMC-Na that was used was 600 to 800, and the viscosity of a 1 wt % CMC-Na aqueous solution was in the range from 300 mPa·s to 500 mPa·s. As the conductive agent, VGCF (registered trademark)-H (manufactured by SHOWA DENKO K.K., the fiber diameter: 150 nm, the specific surface area: 13 m²/g) was used.

A current collector was coated with the formed slurry and then drying was performed, and a negative electrode active material layer was formed on the current collector. As the current collector, copper foil having a thickness of 18 μm was used. The negative electrode active material layer was provided on one surface of the current collector.

### <Fabrication of Positive Electrodes>

Next, positive electrodes were fabricated. As a positive electrode active material in the secondary battery, lithium nickel-cobalt-manganese oxide with Ni:Co:Mn=5:2:3 (atomic ratio) (produced by MTI) was used.

As a conductive agent, graphene oxide (GO) or acetylene black (AB) was used. The graphene oxide is reduced in a later step. The composition proportion of the graphene oxide in the total amount of the active material, the graphene oxide, and a binder was set to 3 wt %.

As the binder, PVDF was used. The composition proportion of the binder in the total amount of the active material, the graphene oxide, and the binder was set to 2 wt %.

For formation of the slurry and reduction of the graphene oxide, the conditions described in Example 1 were used.

After the reduction treatment, application of linear pressure at 120 kN/m was performed, whereby positive electrodes were fabricated. The carried amount of the positive electrode was approximately 10 mg/cm².

### <Fabrication of Secondary Batteries>

With use of the positive electrodes and the negative electrodes fabricated in the above manner, the secondary batteries using films as exterior bodies were fabricated.

As a separator, 25-μm-thick polypropylene was used.

The positive electrode, the separator, and the negative electrode were stacked in this order. Arrangement was performed so that the positive electrode active material provided on the one surface of the current collector faces the negative electrode active material with the separator sandwiched therebetween.

Leads were bonded to the positive electrode and the negative electrode.

A stack in which the positive electrodes, the negative electrode, and the separators are stacked was sandwiched between facing portions of the exterior body that is folded in half, and the stack was placed so that one ends of the leads extend outside the exterior body. Next, one side of the exterior body was left as an aperture, and the other sides were sealed.

As a film to be the exterior body, a film in which a polypropylene layer, an acid modified polypropylene layer, an aluminum layer, and a nylon layer are stacked in this order was used. The thickness of the film was approximately 110 μm. The film to be the exterior body was bent so that the nylon layer is placed as the surface of the exterior body placed on the outer side and the polypropylene layer is placed as the surface of the exterior body placed on the inner side. The thickness of the aluminum layer was approximately 40 μm, the thickness of the nylon layer was approximately 25 μm, and the total thickness of the polypropylene layer and the acid modified polypropylene layer was approximately 45 μm.

Next, in an argon gas atmosphere, an electrolyte solution was introduced from the one side left as an aperture.

As the electrolyte solution, 1 mol/L lithium hexafluorophosphate (LiPF₆) was used. As the electrolyte solution, a solution in which propylene carbonate (PC), ethylmethyl carbonate (EMC), and dimethyl carbonate (DMC) were mixed at a volume ratio of 3:3.5:3.5 was used.

Then, the one side of the exterior body left as an aperture was sealed in a reduced-pressure atmosphere.

Through the above process, six secondary batteries each using the reduced graphene oxide as a conductive agent (hereinafter, referred to as Cell RGO-C1, Cell RGO-C2, Cell RGO-C3, Cell RGO-C4, Cell RGO-C5, and Cell RGO-C6) and five secondary batteries each using the acetylene black (hereinafter, referred to as Cell AB-C1, Cell AB-C2, Cell AB-C3, Cell AB-C4, and Cell AB-C5) were fabricated.

During aging, a retention test, evaluation of electrical characteristics, or the like, gas might be generated in a secondary battery, an exterior body of the secondary battery might be expanded, and volume might change. In this example, a change in volume was measured by the following method.

When an object is immersed in a liquid, the buoyancy that is equal to the weight of the volume of the liquid pushed by the object is applied to the object. Here, when the buoyancy, the density of the liquid, the volume of a portion of the object that is immersed in the liquid, and the gravitational acceleration are represented by F[N], d[kg/m³], V[m³], and g[m/s²], respectively, Formula (1) below is satisfied.

$$\begin{matrix}[ Formula 1 ] & \\ F = d \times V \times g & ( 1 )\end{matrix}$$

In the case where the gravity and the buoyancy are balanced, Formula (2) below is satisfied. The weight m[g] is the weight of the liquid pushed by the object that is immersed in the liquid.

$$\begin{matrix}[ Formula 2 ] & \\ F = d \times V \times g = m \times g & ( 2 )\end{matrix}$$

According to Formula (2), the volume V of the portion of the object that is immersed in the liquid can be represented by Formula (3) below using the weight m and the density d, and calculated from the weight of the liquid pushed by the object that is immersed in the liquid.

$$\begin{matrix}[ Formula 3 ] & \\ V = m / d & ( 3 )\end{matrix}$$

### <Measurement of Weight 1>

The fabricated secondary batteries were put into a tank filled with water, lead electrode portions were clipped, and the secondary batteries were immersed in the water. A clip is suspended from a structure provided independently of a weight scale. Weights increased by immersing the secondary batteries in the water were measured. The results are shown in “weight 1” in Table 2.

TABLE 2

| | weight 1 | weight 2 | weight 3 |
|---|---|---|---|
| RGO-C1 | 3.1 | 5 | 6.4 |
| RGO-C2 | 2.8 | 4.5 | 5.9 |
| RGO-C3 | 2.8 | 4.6 | 5.9 |
| RGO-C4 | 2.9 | 4.7 | 6 |
| RGO-C5 | 3.1 | 4.9 | 7 |
| RGO-C6 | 3 | 4.5 | 6.1 |
| Av (RGO) | 2.95 | 4.70 | 6.22 |
| AB-C1 | 3.1 | 8.4 | 9.9 |
| AB-C2 | 3.1 | 8.4 | 8.8 |
| AB-C3 | 3.1 | 5.9 | 8.8 |
| AB-C4 | 2.8 | 7.9 | 8.8 |
| AB-C5 | 3 | 6.9 | 8.6 |
| Av (AB) | 3.02 | 7.50 | 8.98 |

### <Aging>

Next, the secondary batteries were subjected to aging.

First, the secondary battery was sandwiched between two plates and CC charging (0.01 C, a capacity of 15 mAh/g) was performed. Here, CC denotes constant current. Here, the capacity of the secondary battery per weight of the positive electrode active material was calculated. The C rate was calculated by setting 1 C in accordance with the conditions for charge and discharge cycles.

Next, CC charging (0.1 C, a capacity of 120 mAh/g) was performed.

### <Measurement of Weight 2>

After that, the two plates were removed, the secondary batteries were put into a tank filled with water, and weights increased by immersing the secondary batteries in the water were measured. The results are shown in “weight 2” in Table 2 above.

### <Retention>

Then, retention was performed at 40° C. for 24 hours.

### <Measurement of Weight 3>

After that, the secondary batteries were put into a tank filled with water, the secondary batteries were immersed in the water, and weights increased by immersing the secondary batteries in the water were measured. The results are shown in “weight 3” in Table 2 above.

Table 3 shows that the secondary batteries each using the reduced graphene oxide as a conductive agent in the positive electrode had smaller weights than the secondary batteries each using the acetylene black. This indicates that the use of the reduced graphene oxide as a conductive agent in the positive electrode suppressed generation of gas due to aging and retention at 40° C. and suppressed expansion of the exterior body of the secondary battery.

### Example 4

In this example, the electrodes fabricated in Example 2 were subjected to SEM observation.

### <Disassembly of Batteries>

The secondary batteries that were charged and discharged until the discharge capacity rapidly decreased were disassembled, and the positive electrodes were extracted. The disassembly was performed in an argon atmosphere. After the disassembly, washing with DMC was performed, and the solvent was volatilized.

### <SEM Observation>

Next, the positive electrodes taken from the disassembled secondary batteries were put in a container held in an argon atmosphere; the container was transferred to a transfer chamber; the air atmosphere was ejected by reducing pressure with a pump; and then the container was opened, whereby the positive electrodes were observed without being exposed to the air atmosphere. The observation was performed with the use of a scanning electron microscope (SEM). As the SEM, SU8030 manufactured by Hitachi High-Tech Corporation was used. The accelerating voltage was 5 kV.

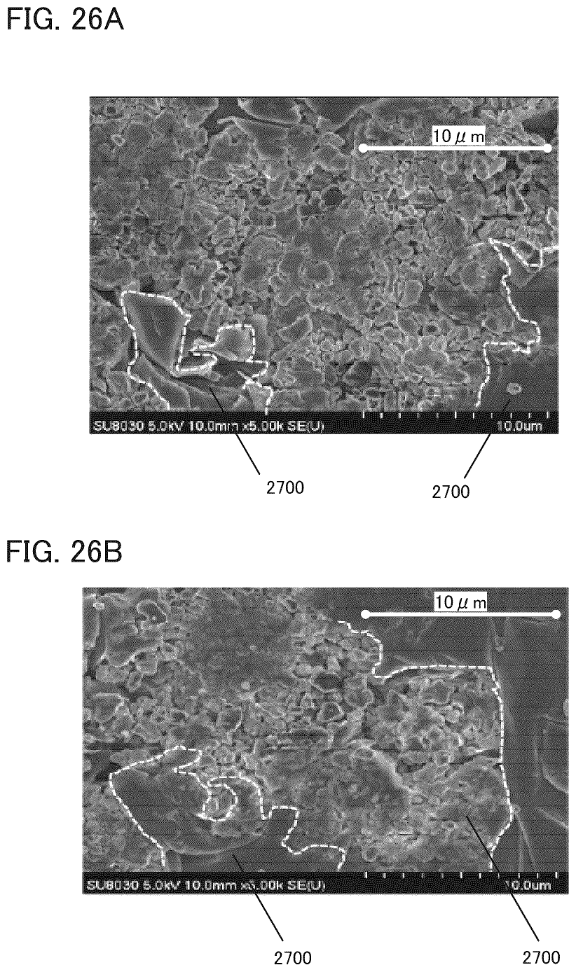

FIG. 26 shows SEM images of the positive electrodes each using graphene oxide at 3 wt□ as a conductive agent. FIG. 26A shows the positive electrode in which discharge capacity does not decrease, and FIG. 26B shows the positive electrode in which discharge capacity slightly decreased. FIG. 26A and FIG. 26B each show a graphene compound 2700.

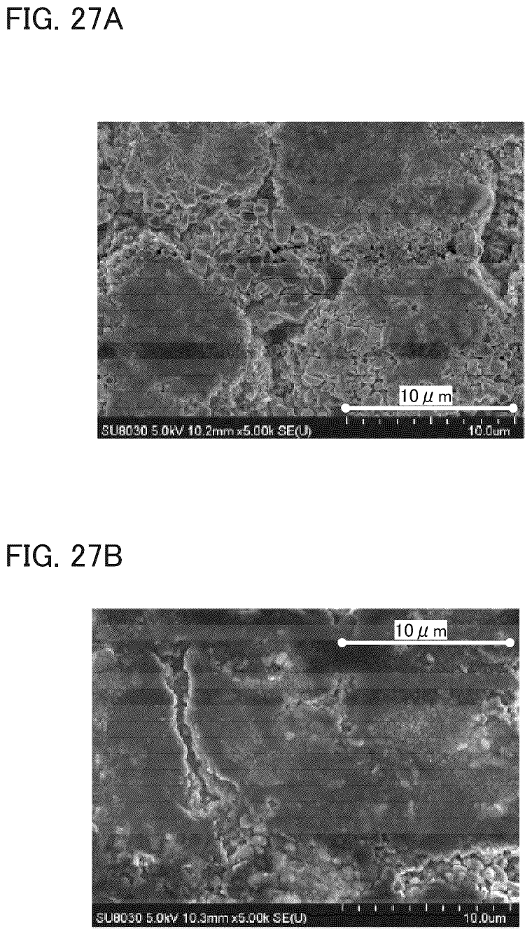

FIG. 27 shows SEM images of the positive electrodes each using acetylene black at 3 wt□ as a conductive agent. FIG. 27A shows the positive electrode in which discharge capacity does not decrease, and FIG. 27B shows the positive electrode in which discharge capacity rapidly decreased.

As described above, when the positive electrodes after charge and discharge cycles were observed, the graphene compound was observed. In the electrode using acetylene black, a substance that is probably a decomposition product of an electrolyte solution was observed, and a decrease in capacity may be caused due to the decomposition product. Meanwhile, the electrode using a graphene oxide compound included a smaller number of substances that are probably decomposition products than the electrode using acetylene black. Therefore, it is considered that a decrease in capacity due to charge and discharge cycles was suppressed.

### REFERENCE NUMERALS

101: graphene, 103: space in a heating furnace, 104: hot plate, 106: heater unit, 108: heat insulator, 116: container, 118: lid, 119: space, 120: heating furnace, 200: electrode, 201: current collector, 201a: titanium compound, 202: active material layer, 203: active material, 203a: active material, 203b: active material, 207: carbon-containing compound, 207a: carbon-containing compound, 207b: carbon-containing compound, 207c: carbon-containing compound, 207x: carbon-containing compound, 207y: carbon-containing compound, 208: secondary particle, 212: protrusion portion, 214: graphene, 221: region, 222: region, 223: region, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 400: secondary battery, 410: positive electrode, 411: positive electrode active material, 413: positive electrode current collector, 414: positive electrode active material layer, 420: solid electrolyte layer, 421: solid electrolyte, 430: negative electrode, 431: negative electrode active material, 433: negative electrode current collector, 434: negative electrode active material layer, 500: secondary battery, 503: positive electrode, 506: negative electrode, 507: separator, 509: exterior body, 510: positive electrode lead electrode, 511: negative electrode lead electrode, 600: secondary battery, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 612: safety valve mechanism, 613: conductive plate, 614: conductive plate, 615: module, 616: conductive wire, 617: temperature control device, 881: lithium atom, 882: cobalt atom, 883: lithium layer, 884: lithium ion, 901: lithium oxide, 902: fluoride, 903: mixture, 904: positive electrode active material, 913: secondary battery, 930: housing, 931: negative electrode, 932: positive electrode, 933: separator, 950: wound body, 951: terminal, 952: terminal, 2100: mobile phone, 2101: housing, 2102: display portion, 2103: operation button, 2104: external connection port, 2105: speaker, 2106: microphone, 2107: secondary battery, 2300: unmanned aircraft, 2301: secondary battery, 2302: rotor, 2303: camera, 2601: secondary battery, 2602: secondary battery, 2603: vehicle, 2604: charging equipment, 2610: solar panel, 2611: wiring, 2612: power storage system, 2700: graphene compound

This application is based on Japanese Patent Application Serial No. 2019-239306 filed on Dec. 27, 2019 and on Japanese Patent Application Serial No. 2020-008976 filed on Jan. 23, 2020, the entire contents of each are hereby incorporated herein by reference.

1. A method for manufacturing a secondary battery comprising a positive electrode, the method comprising the steps of:
forming slurry by mixing graphene oxide, a binder, and a positive electrode active material comprising lithium nickel-cobalt-manganese oxide;
applying the slurry to a current collector after forming the slurry;
drying the slurry after the applying;
forming a solution comprising L-ascorbic acid and lithium hydroxide;
immersing and reacting the current collector with the slurry in the solution;
performing thermal reduction to the slurry on the current collector; and
forming the positive electrode by performing application of linear pressure to the slurry after the performing thermal reduction.
